(19) United States
(12) Patent Application Publication
(10) Pub. No.: US 2018/0041401 A1
(43) Pub. Date: Feb. 8, 2018

(54) System Diagram GUI Development System and Method of Use

(71) Applicant: EDT Expert Design Tools, LLC, Austin, TX (US)

(72) Inventor: Christopher Hugman, Austin, TX (US)

(21) Appl. No.: 15/667,279

(22) Filed: Aug. 2, 2017

Related U.S. Application Data
(60) Provisional application No. 62/369,945, filed on Aug. 2, 2016.

(51) Int. Cl. H04L 12/24

(52) U.S. Cl. CPC H04L 41/22; H04L 41/12; H04L 41/085; H04L 41/0866

(57) ABSTRACT

A site diagram system for use by a user for capturing a physical and/or logical layout of a one or more networked devices, to plan a one or more sites or to create a system diagram or a install checklist. said site diagram system comprising a one or more computers. Said one or more computers comprising a processor and a memory. Said processor configured to run a device application. Said device application configured to create said system diagram. Said device application comprises a surveys list comprising a record of a one or more surveys comprising at least a first survey. each among said one or more surveys comprising a data collected by said user concerning a site location. Said one or more surveys comprising a survey map and a one or more placed icons. Said survey map comprising a representation of said site location including floor plans and similar.

### CROSS-REFERENCE TO RELATED APPLICATIONS

This application claims benefit to U.S. Patent Application No. 62/369,945 filed on Aug. 2, 2016.

### STATEMENT REGARDING FEDERALLY SPONSORED RESEARCH OR DEVELOPMENT (IF APPLICABLE)

Not applicable.

### REFERENCE TO SEQUENCE LISTING, A TABLE, OR A COMPUTER PROGRAM LISTING COMPACT DISC APPENDIX (IF APPLICABLE)

Not applicable.

### BACKGROUND OF THE INVENTION

This disclosure relates generally to a system diagram GUI development system and method of use. Examples of GUI systems can be found at U.S. Pat. No. 6,326,946 B1, U.S. Pat. No. 9,104,300 B2, U.S. Pat. No. 8,255,338 B1, U.S. Pat. No. 8,549,013 B1, and US 20020059253 A1. None of the above inventions and patents, taken either singularly or in combination, is seen to describe the instant disclosure as claimed. Accordingly, an improved system diagram GUI would be advantageous.

### BRIEF SUMMARY OF THE INVENTION

A site diagram system for use by a user for capturing a physical and/or logical layout of a one or more networked devices, to plan a one or more sites or to create a system diagram or a install checklist. said site diagram system comprising a one or more computers. Said one or more computers comprising a processor and a memory. Said processor configured to run a device application. Said device application configured to create said system diagram. Said device application comprises a surveys list comprising a record of a one or more surveys comprising at least a first survey. each among said one or more surveys comprising a data collected by said user concerning a site location. Said one or more surveys comprising a survey map and a one or more placed icons. Said survey map comprising a representation of said site location including floor plans and similar. Said one or more placed icons comprising representations of assets to be placed on said survey map. Said one or more placed icons each comprise an asset settings. Said device application comprises said survey map configured to receive a one or more among said one or more placed icons and to capture said asset settings related to said one or more placed icons. Said one or more placed icons can be grouped together in a one or more containers, wherein, each of said one or more containers comprise a one or more zones related to each of said one or more placed icons within said one or more containers. Said device application is configured to create a new container when said user drags said new container onto said survey map, combine a one or more of said one or more placed icons into said new container, and configuring said asset settings for said new container.

A site diagram system for use by a user for capturing a physical and/or logical layout of a one or more networked devices, to plan a one or more sites or to create a system diagram or a install checklist. said site diagram system comprising a one or more computers. Said one or more computers comprising a processor and a memory. Said processor configured to run a device application. Said device application configured to create said system diagram. Said device application comprises a surveys list comprising a record of a one or more surveys comprising at least a first survey. each among said one or more surveys comprising a data collected by said user concerning a site location. Said one or more surveys comprising a survey map and a one or more placed icons. Said survey map comprising a representation of said site location including floor plans and similar. Said one or more placed icons comprising representations of assets to be placed on said survey map. Said one or more placed icons each comprise an asset settings. Said device application comprises said survey map configured to receive a one or more among said one or more placed icons and to capture said asset settings related to said one or more placed icons. Said one or more placed icons can be grouped together in a one or more containers, wherein, each of said one or more containers comprise a one or more zones related to each of said one or more placed icons within said one or more containers. Said device application is configured to create a new container when said user drags said new container onto said survey map, combine a one or more of said one or more placed icons into said new container, and configuring said asset settings for said new container.

A site diagram system for use by a user for capturing a physical and/or logical layout of a one or more networked devices, to plan a one or more sites or to create a system diagram or a install checklist. said site diagram system comprising a one or more computers. Said one or more computers comprising a processor and a memory. Said processor configured to run a device application. Said device application configured to create said system diagram. Said device application comprises a surveys list comprising a record of a one or more surveys comprising at least a first survey. each among said one or more surveys comprising a data collected by said user concerning a site location. Said one or more surveys comprising a survey map and a one or more placed icons. Said survey map comprising a representation of said site location including floor plans and similar. Said one or more placed icons comprising representations of assets to be placed on said survey map. Said one or more placed icons each comprise an asset settings. Said device application comprises said survey map configured to receive a one or more among said one or more placed icons and to capture said asset settings related to said one or more placed icons. Said one or more placed icons comprise a camera icon. Said camera icon comprise a representation of a video surveillance devices. Said device application is configured to capture a depth of field data for said camera icon by receiving said camera icon in said survey map, displaying a depth of field input markers on said camera icon, receiving a depth input, an angle input, and a one or more width inputs with said depth of field input markers, rendering a depth of field indication on said camera icon, and recording said depth of field data for said camera icon.

### BRIEF DESCRIPTION OF THE SEVERAL VIEWS OF THE DRAWING

FIG. 1 illustrates block diagram view of a site diagram system 100.

FIG. 2A illustrates a perspective overview view of a mobile phone 201a.

FIG. 2B illustrates a perspective overview view of a personal computer 201b.

FIG. 2C illustrates a perspective overview view of a tablet 201c.

FIG. 3A illustrates block diagram view of an address space 302.

FIG. 3B illustrates block diagram view of an address space 302a.

FIG. 3C illustrates block diagram view of an address space 302d.

FIG. 4A illustrates block diagram view of a data storage 110.

FIG. 4B illustrates block diagram view of a data storage 110a.

FIG. 5A illustrates block diagram view of a memory 306.

FIG. 5B illustrates block diagram view of a memory 306a.

FIG. 6 illustrates discussion illustration view of an user 600.

FIG. 7 illustrates UI view of a list of sites screen 702.

FIG. 8 illustrates UI view of a site overview screen 802.

FIG. 9 illustrates a view of a new survey flow chart 900.

FIG. 10 illustrates a view of an open survey flow chart 1000.

FIG. 11A illustrates UI view of a survey edit screen 1102.

FIG. 11B illustrates UI view of a containers devices 1104e.

FIG. 11C illustrates UI view of a security zones devices 1104f.

FIG. 12A illustrates a view of an empty container example 1200a.

FIG. 12B illustrates a view of a filling a new container example 1200b.

FIG. 12C illustrates a view of a combing multiple icons example 1200c.

FIG. 12D illustrates a flow chart view of a container creation procedure 1250.

FIG. 13 illustrates UI view of an asset properties screen 1302.

FIG. 14 illustrates UI view of an annotation interface 1402.

FIG. 15 illustrates UI view of an annotation interface 1402.

FIG. 16 illustrates UI view of a survey assets screen 1602.

FIG. 17A illustrates a first UI view of a survey map 1106a.

FIG. 17B illustrates a second UI view of a survey map 1106a.

FIG. 18 illustrates a flow chart view of an asset icon movement detected procedure 1800.

FIG. 19 illustrates a flow chart view of a measure effect of change step 1812.

FIG. 20 illustrates a perspective overview view of a personal computer 201b.

FIG. 21A illustrates UI view of a first configuration 2100a.

FIG. 21B illustrates UI view of a second configuration 2100b.

FIG. 21C illustrates UI view of a third configuration 2100c.

FIG. 21D illustrates UI view of a fourth configuration 2100d.

FIG. 22 illustrates a view of a new camera icon set up flow chart 2200.

FIG. 23A illustrates UI view of a physical topology screen 2300.

FIG. 23B illustrates UI view of a logical topology screen 2310.

### DETAILED DESCRIPTION OF THE INVENTION

The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

These parts are illustrated in the figures and discussed below:
a site diagram system 100
a one or more computers 102
a first computer 102a
a second computer 102b
a third computer 102c
a one or more locations 103
a first location 103a
a second location 103b
a third location 103c
a printer 104
a network 106
a server 108
a data storage 110
a data storage 110a
a network configuration 112
a mobile phone 201a
a personal computer 201b
a tablet 201c
a screen 202
a one or more input devices 204
a keyboard 204a
a trackball 204b
a one or more cameras 204c
a track pad 204d
a home button 220
an address space 302
an address space 302a
an address space 302b
an address space 302c
an address space 302d
a processor 304
a processor 304a
a processor 304b
a processor 304c
a processor 304d
a memory 306
a memory 306a
a memory 306b
a memory 306c
a memory 306d
a communication hardware 308
a communication hardware 308a
a communication hardware 308b
a communication hardware 308c
a communication hardware 308d
a device application 502
a data records 504a
a data records 504b
a data records 504c
a data records 504d
a server application 506
an user 600
a site location 602
a system diagram 604
an install checklist 606
a list of sites screen 702
a one or more zones 704
a list of sites zone 704a
a navigation zone 704b
an advertising zone 704c
a team library zone 704d
a one or more columns 706
a site description column 706a
a site meta data column 706b
a one or more sites 708
a first site 708a
a second site 708b
a one or more open site buttons 710
an open first site button 710a
an open second site button 710b
a navigation buttons 720
an add site button 720a
a refresh button 720b
a delete site button 720c
an user info button 720d
a current user 740
a one or more shared assets 742
a first shared asset 742a
a second shared asset 742b
a site overview screen 802
a one or more lists 804
a surveys list 804a
a site information list 804b
a contributors list 804c
a navigation list 804d
a one or more columns 806
a survey description column 806a
a survey meta data column 806b
a one or more surveys 808
a first survey 808a
a second survey 808b
a one or more open survey buttons 810
an open first survey button 810a
an open second survey button 810b
an user list 812
a one or more users 814
a first user 814a
a second user 814b
an add user button 816a
a remove user button 816b
a navigation buttons 820
a new survey button 820a
a refresh button 820b
a delete survey button 820c
a one or more request edit buttons 822
a first request edit button 822a
a second request edit button 822b
a one or more release edit buttons 824
a first release edit button 824a
a second release edit button 824b
a one or more send URL buttons 826
a first send URL button 826a
a second send URL button 826b
a new survey flow chart 900
a new survey button pressed step 902
a survey creation options 904
a scanning steps 906
an use template steps 908
a draw new survey steps 910
a capture meta data step 912
a save and exit step 914
an exit procedure step 916
an open survey flow chart 1000
an open survey button pressed step 1002
a check out survey steps 1004
a close survey steps 1006
an exit procedure step 1008
a survey edit screen 1102
a one or more tool tabs 1104
a video surveillance devices 1104a
an access control devices 1104b
an intrusion detection devices 1104c
an information technology devices 1104d
a containers devices 1104e
a security zones devices 1104f
a one or more zones 1106
a survey map 1106a
a sidebar zone 1106b
a navigation zone 1106c
a one or more icons 1108
a first icon 1108a
a second icon 1108b
a third icon 1108c
a one or more placed icons 1110
a first placed icon 1110a
a second placed icon 1110b
a one or more navigation buttons 1120
a save button 1120a
a back button 1120b
an undo button 1120c
an asset properties button 1120d
a draw container button 1120e
a duplicate asset button 1120f
a group button 1120g
an import assets button 1120h
a one or more containers 1130
a first container 1130a
a second container 1130b
a third container 1130c
a new container 1132
a one or more regions 1140
a first region 1140a
a second region 1140b
an empty container example 1200a
a filling a new container example 1200b
a combing multiple icons example 1200c
a container placed on map step 1202a
a multiple icons combined step 1202b
a new or template container created step 1204a
a new container created step 1204b
a new container populated step 1206
an exit procedure step 1208
a container creation procedure 1250
an asset properties screen 1302
a one or more zones 1304
an asset settings 1304a
an asset information 1304b
an asset images 1304c
a navigation zone 1304d
an asset status 1304e
a work completed zone 1304f
a one or more columns 1306
a setting description column 1306a
a detail column 1306b
a one or more settings 1308
a first setting 1308a
a second setting 1308b
an edit image button 1310a
a capture image button 1310b
a one or more images 1312
an annotated image 1312a
an unannotated image 1312b
an edit attribute button 1314a
a create attribute button 1314b
an operational info button 1314c
a new status button 1316
a one or more previous tasks 1318
a first task 1318a
a second task 1318b
a one or more navigation buttons 1320
a save button 1320a
a back button 1320b
an undo button 1320c
an icon properties button 1320d
an annotation interface 1402
a navigation zone 1406d
a displayed image 1410
a one or more navigation buttons 1420
a zoom button 1420a
a pencil button 1420b
a draw shape button 1420c
an add annotation button 1420d
an undo button 1420e
a pre-defined labels button 1420f
a first typed annotation 1504
a first drawn annotation 1506
a survey assets screen 1602
a one or more zones 1604
an assets list 1604a
a navigation zone 1604b
a one or more columns 1606
a product description column 1606a
an inventory column 1606b
an order delay column 1606c
a specifications column 1606d
a category column 1606e
a generic flag column 1606f
a one or more products 1608
a fixed camera 1608a
a second product 1608b
a third product 1608c
a fourth product 1608d
a fifth product 1608e
a sixth product 1608f
a one or more edit details buttons 1610
an edit details button 1610a
an edit details button 1610b
an edit details button 1610c
an edit details button 1610d
an edit details button 1610e
an edit details button 1610f
a one or more buttons 1620
a save button 1620a
a back button 1620b
an undo button 1620c
a set up vendors button 1620d
a new button 1620e
a plurality of icons 1702
a first icon 1702a
a second icon 1702b
a camera icon 1702c
a first distance 1704a
a second distance 1704b
an asset relationship 1720
a first asset relationship 1720a
an asset icon movement detected procedure 1800
an asset icon movement detected step 1802
a movement input step 1804
a look for associations step 1806
a no associations found step 1808
an associations found step 1810
a measure effect of change step 1812
an exit procedure step 1814
a classify step 1902
a break association step 1904
a break association step 1906
an exit procedure step 1908
a one or more configurations 2100
a first configuration 2100a
a second configuration 2100b
a third configuration 2100c
a fourth configuration 2100d
a depth input 2102
an angle input 2104
a one or more width inputs 2106
a first width input 2106a
a second width input 2106b
a depth of field indication 2108
a depth of field input markers 2110
a new camera icon set up flow chart 2200
a camera icon placed on map event 2202
a display input markers event 2204
a receive depth of field inputs step 2206
an update settings for new camera icon step 2208
an update icon for new camera icon step 2210
an exit step 2212
a physical topology screen 2300
a one or more routers 2302
a first router 2302a
a second router 2302b
a one or more switch-gateways 2304
a first switch-gateway 2304a
a second switch-gateway 2304b
a one or more networked devices 2306
a first networked device 2306a
a second networked device 2306b
a third networked device 2306c
a fourth networked device 2306d
a fifth networked device 2306e
a sixth networked device 2306f
a seventh networked device 2306g
an eight networked device 2306h
a one or more connection lines 2308
a physical connection line 2308a
a wireless connection line 2308b
a logical topology screen 2310
an internet icon 2312
a local zone 2314
a one or more switch zones 2316
a first switch zone 2316a
a second switch zone 2316b
a one or more IP information 2318
a first IP information 2318a
a second IP information 2318b
a third IP information 2318c
a fourth IP information 2318d
a fifth IP information 2318e
a sixth IP information 2318f
a seventh IP information 2318g
an eight IP information 2318h
a ninth IP information 2318k
a tenth IP information 2318m
an eleventh IP information 2318n
a remote server 2320

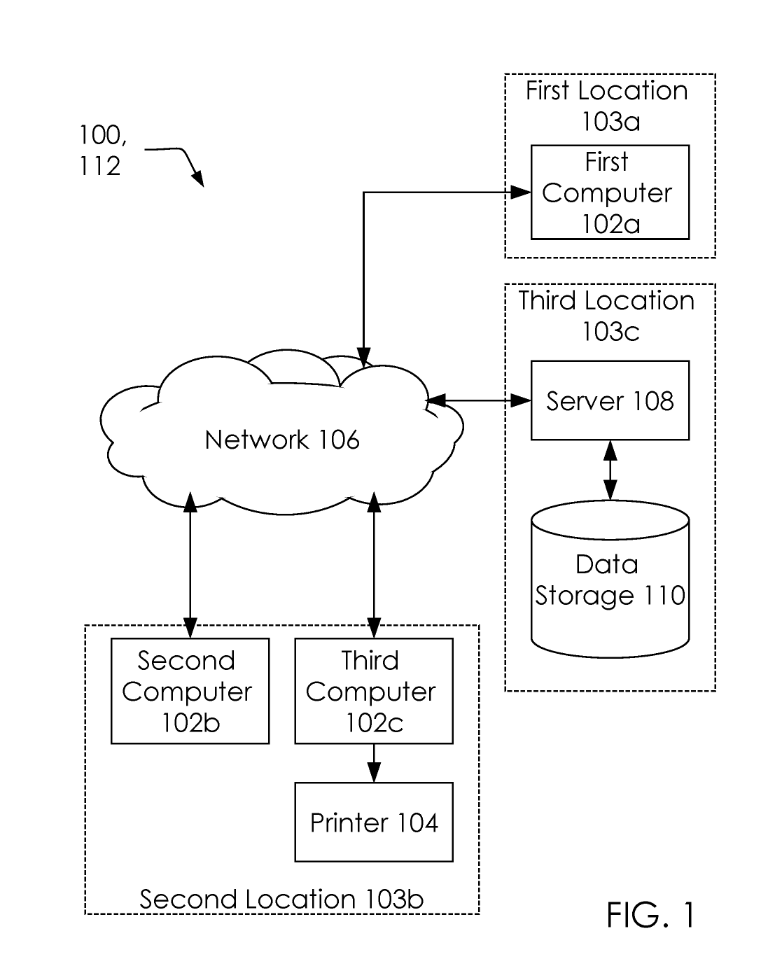

FIG. 1 illustrates block diagram view of a site diagram system 100.

In one embodiment, said site diagram system 100 can comprise said network configuration 112.

In one embodiment, said site diagram system 100 can comprise a one or more computers at a one or more locations. In one embodiment, said one or more computers can comprise a first computer 102a, a second computer 102b and a third computer 102c. In one embodiment, said one or more locations can comprise a first location 103a, a second location 103b and a third location 103c. In one embodiment, said first location can comprise a field location. In one embodiment, said one or more computers can communicate on a network 106, which can connect to a one or more servers (such as a server 108). In one embodiment, a printer 104 can be hardwired to said first computer 102a (not illustrated here), or said printer 104 can connect to one of said one or more computers (such as said third computer 102c, illustrated) via network 106.

Said network 106 can be a local area network (LAN), a wide area network (WAN), a piconet, or a combination of LANs, WANs, or piconets. One illustrative LAN is a network within a single business. One illustrative WAN is the Internet.

In one embodiment, said server 108 represents at least one, but can be many servers, each connected to said network 106. Said server 108 can connect to a data storage 110. Said data storage 110 can connect directly to said server 108, as shown in FIG. 1, or may exist remotely on said network 106. In one embodiment, said data storage 110 can comprise any suitable long-term or persistent storage device and, further, may be separate devices or the same device and may be collocated or distributed (interconnected via any suitable communications network).

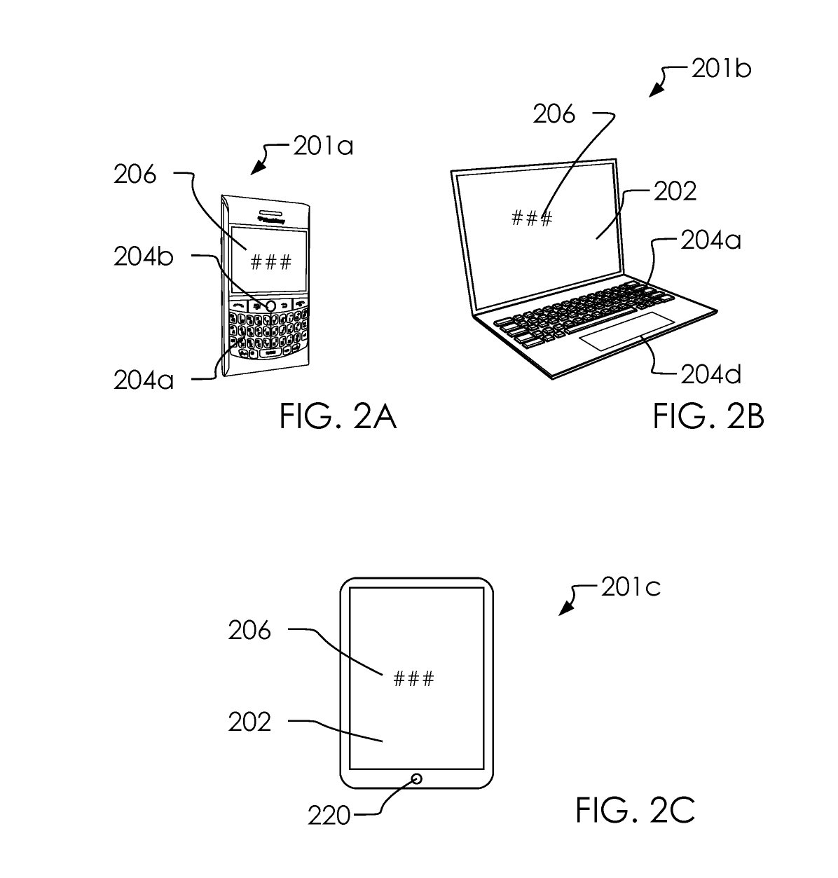

FIG. 2A illustrates a perspective overview view of a mobile phone 201a.

FIG. 2B illustrates a perspective overview view of a personal computer 201b.

FIG. 2C illustrates a perspective overview view of a tablet 201c.

In the last several years, the useful definition of a computer has become more broadly understood to include mobile phones, tablet computers, laptops, desktops, and similar. For example, Microsoft®, have attempted to merge devices such as a tablet computer and a laptop computer with the release of “Windows® 8”. In one embodiment, said one or more computers each can include, but is not limited to, a laptop (such as said personal computer 201b), desktop, workstation, server, mainframe, terminal, a tablet (such as said tablet 201c), a phone (such as said mobile phone 201a), and/or similar. Despite different form-factors, said one or more computers can have similar basic hardware, such as a screen 202 and a one or more input devices (such as a keyboard 204a, a trackball 204b, a one or more cameras 204c, a wireless—such as RFID—reader, a track pad 204d, and/or a home button 220). In one embodiment, said screen 202 can comprise a touch screen. In one embodiment, said track pad 204d can function similarly to a computer mouse as is known in the art. In one embodiment, said tablet 201c and/or said personal computer 201b can comprise a Microsoft® Windows® branded device, an Apple® branded device, or similar. In one embodiment, said tablet 201c can be an X86 type processor or an ARM type processor, as is known in the art.

Said site diagram system 100 can comprise a data 206. In one embodiment, said data 206 can comprise data related to financial transactions.

In one embodiment, said one or more computers can be used to input and view said data 206. In one embodiment, said data 206 can be input into said one or more computers by taking pictures with one of said one or more camera 204c, by typing in information with said keyboard 204a, or by using gestures on said screen 202 (where said screen 202 is a touch screen). Many other data entry means for devices similar to said one or more computers are well known and herein also possible with data 206. In one embodiment, said first computer 102a can comprise an iPhone®, a BlackBerry®, a smartphone, or similar. In one embodiment, one or more computers can comprise a laptop computer, a desktop computer, or similar.

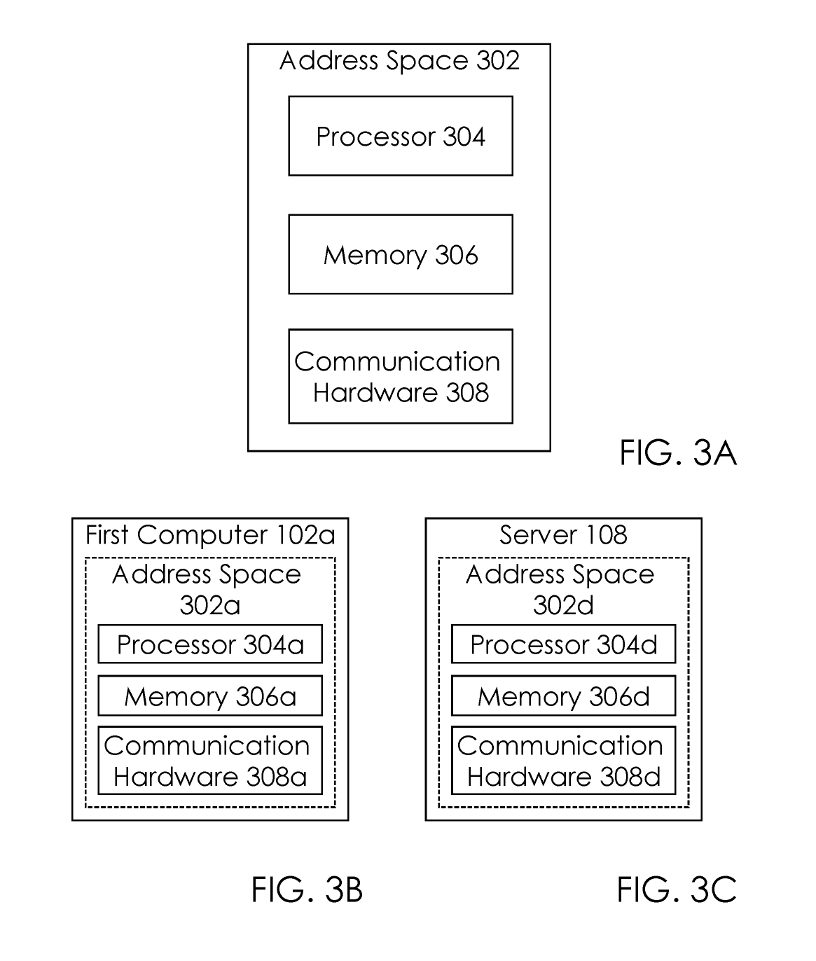

FIG. 3A illustrates block diagram view of an address space 302.

FIG. 3B illustrates block diagram view of an address space 302a.

FIG. 3C illustrates block diagram view of an address space 302d.

Each among said one or more computers and said server 108 can comprise an embodiment of address space 302. In one embodiment, said address space 302 can comprise a processor 304, a memory 306, and a communication hardware 308. In one embodiment, said processor 304 can comprise a plurality of processors, said memory 306 can comprise a plurality of memory modules, and said communication hardware 308 can comprise a plurality of communication hardware components. In one embodiment, said data 206 can be sent to said processor 304; wherein, said processor 304 can perform processes on said data 206 according to an application stored in said memory 306, as discussed further below. Said processes can include storing said data 206 into said memory 306, verifying said data 206 conforms to a one or more preset standards, or ensuring a required set among said required data 206 has been gathered for said data management system and method. In one embodiment, said data 206 can include data which said one or more computers can populate automatically, such as a date and a time, as well as data entered manually. Once a portion of gathering data has been performed said data 206 can be sent to said communication hardware 308 for communication over said network 106. Said communication hardware 308 can include a network transport processor for packetizing data, communication ports for wired communication, or an antenna for wireless communication. In one embodiment, said data 206 can be collected in one or more computers and delivered to said server 108 through said network 106.

In one embodiment, said first computer 102a can comprise said address space 302a, a processor 304a, a memory 306a, and a communication hardware 308a. Likewise, in one embodiment, said server 108 can comprise said address space 302d, a processor 304d, a memory 306d, and a communication hardware 308d.

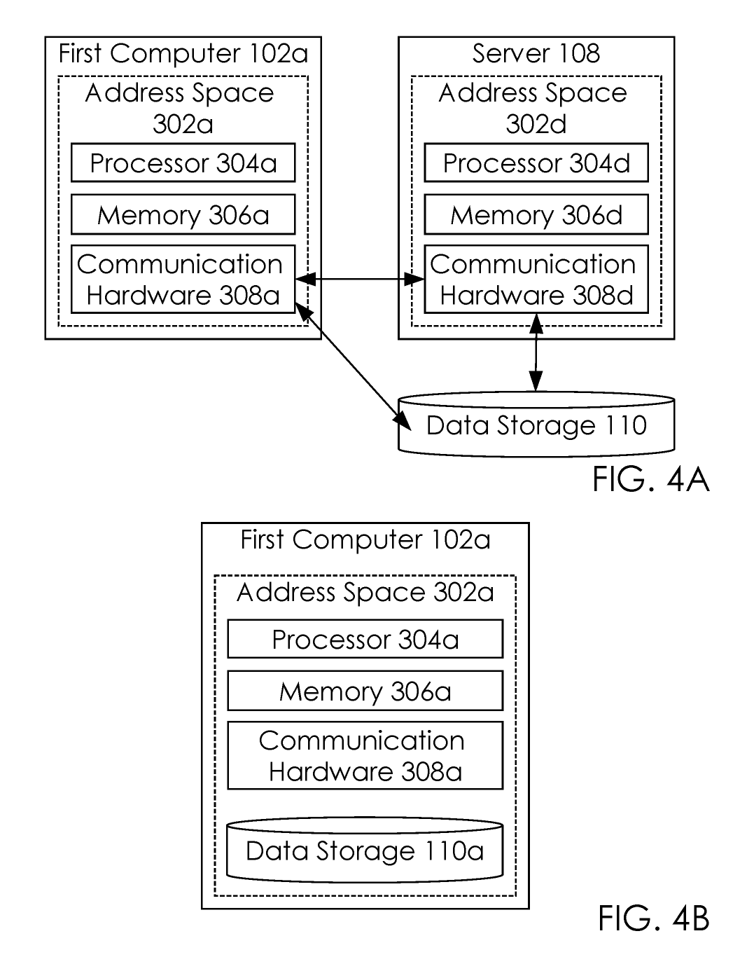

FIG. 4A illustrates block diagram view of a data storage 110.

FIG. 4B illustrates block diagram view of a data storage 110a.

In the first embodiment, said communication hardware 308a and said communication hardware 308d can send and receive data to and from one another and or can communicate with said data storage 110 across said network 106. Likewise, in the second embodiment, data storage 110 can be embedded inside of said one or more computers as a data storage 110a, which may speed up data communications by said site diagram system 100. In another embodiment, said data can be stored temporarily on said data storage 110a and later moved to said data storage 110 for backup and sharing purposes.

As illustrated in FIG. 4A, in one embodiment, said server 108 can comprise a third party data storage and hosting provider or privately managed as well.

As illustrated in FIG. 4B, said data storage 110 can be located on said first computer 102a, here labeled as said data storage 110a. Thus, said first computer 102a can operate on and modify data without a data connection out to said server 108 while performing said system and method for field capture of data. Based upon either a manual or automatic trigger, the altered data is subsequently uploaded over a data connection to said server 108 and made available to other users within a defined group.

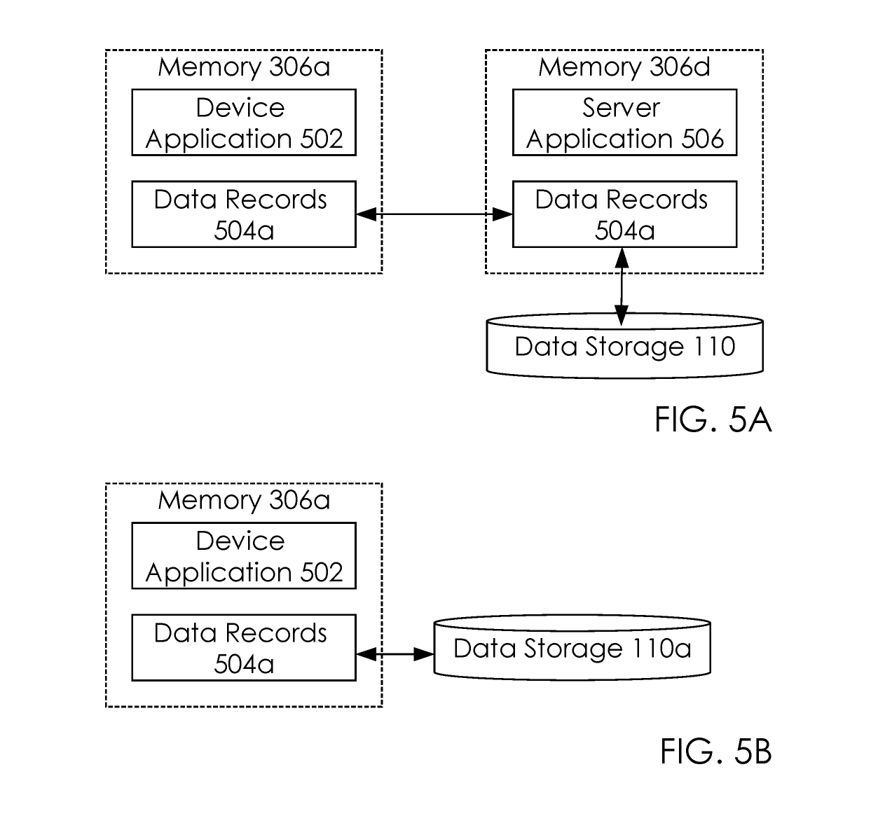

FIG. 5A illustrates block diagram view of a memory 306.

FIG. 5B illustrates block diagram view of a memory 306a.

As illustrated in FIG. 5A, in one embodiment, said site diagram system 100 can process said data 206 on said first computer 102a and/or said server 108. For example, in one embodiment, said memory 306a can comprise a device application 502 capable of generating a data records 504 from user inputs or, otherwise, processing said data records 504 delivered to said device application 502 from said data storage 110. In one embodiment, said data records 504 can be transferred between said device application 502 on said memory 306a of said first computer 102a and a server application 506 in said memory 306d of said server 108. In one embodiment, said server 108 can be useful for processing said data 206, as is known in the art. As illustrated in FIG. 5B, in another embodiment, said server 108 can be removed from the flow diagram entirely as said memory 306a is capable of processing said data records 504 and/or said data 206 without the assistance of said server 108.

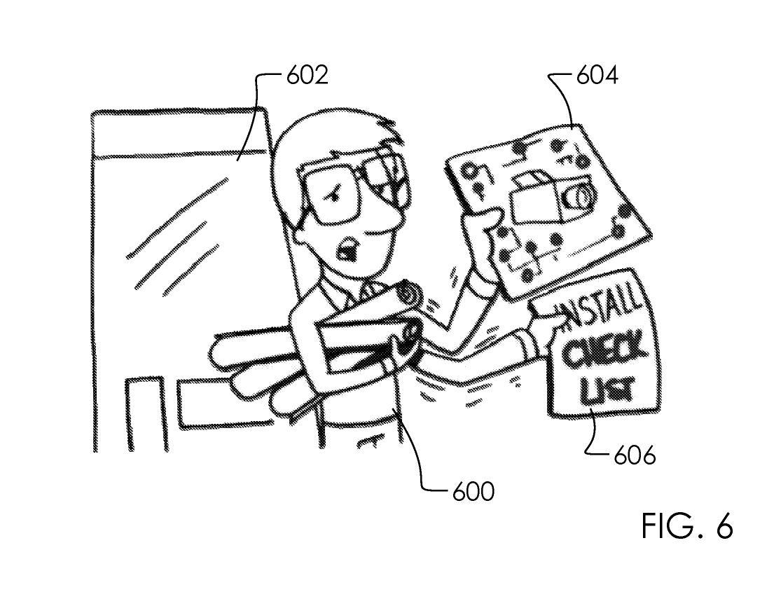

FIG. 6 illustrates discussion illustration view of an user 600.

Said user 600 can use said site diagram system 100 at a site location 602 for ease of planning and to reduce paperwork and confusion in the form of a system diagram 604 and an install checklist 606.

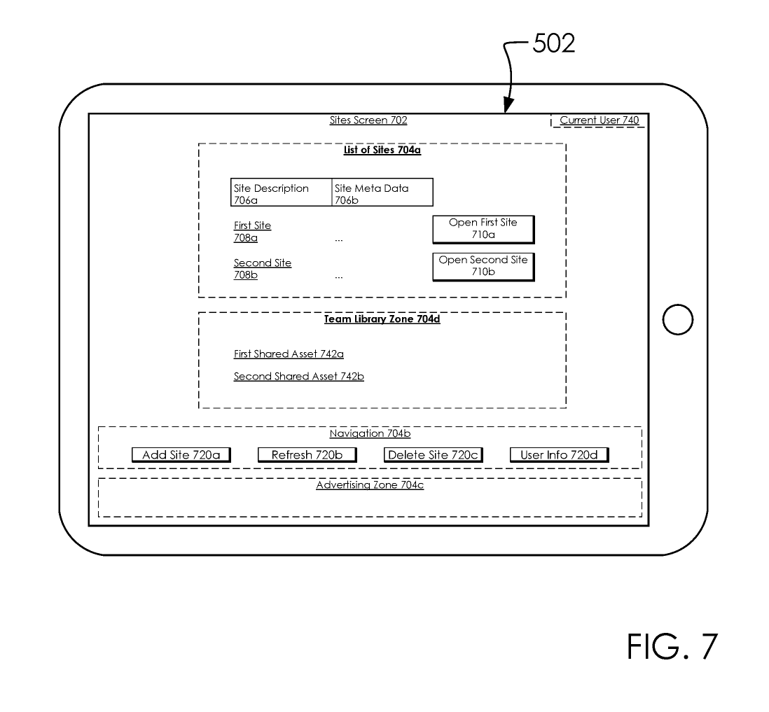

FIG. 7 illustrates UI view of a list of sites screen 702.

In one embodiment, said one or more zones 704 can comprise said advertising zone 704c.

Said list of sites screen 702 can comprise a one or more zones which are adapted to show different but, often, related content. Said one or more zones can comprise a list of sites zone 704a, a navigation zone 704b and an advertising zone 704c.

This disclosure begins with a list of sites which may be related to a particular user. As with other information management interfaces, said device application 502 can begin by having a user log into the system (not illustrated), which is followed by a list of resources related to that user or available to that user based upon group associations or assigned privileges. Here, for example, a current user 740 may a one or more sites 708 which are associated with him; viz., a first site 708a and a second site 708b. In one embodiment, said list of sites zone 704a can comprise a table comprising a one or more columns 706 comprising a site description column 706a and a site meta data column 706b. said one or more sites 708 can be organized under said site description column 706a and myriad data can be summarized and organized under one or more columns which are compressed here as said site meta data column 706b. In one embodiment, said list of sites zone 704a can further comprise a one or more open site buttons 710 (which can comprise an open first site button 710a and an open second site button 710b), each of which are related to one among said one or more sites 708.

Said navigation zone 704b can comprise a navigation buttons 720 which can comprise an add site button 720a (for creating a new site among said one or more sites 708), a refresh button 720b (for refreshing said list of sites screen 702), a delete site button 720c (for deleting one or more among said one or more sites 708), and a user info button 720d (for editing data related to said current user 740).

The user may also access additional site data records stored on data storage 110 by selecting a one or more assets stored in a team library zone 704d. In one embodiment, said team library zone 704d can comprise a one or more shared assets 742 (which can comprise a first shared asset 742a and a second shared asset 742b). In one embodiment, said one or more shared assets 742 can comprise one or more containers, icons, settings files, or similar as described below.

In one embodiment, said advertising zone 704c can display an advertising banner or similar, as is known in the art where the selection of the advertisement presented is based upon user interaction with the application, or direct user input.

As illustrated, said device application 502 is shown rendered in a tablet computer (possibly as a native app). However, said device application 502 can be run on a PC (Windows/Linux/Macintosh/etc.) but can also be run in a web browser as a website service, as is known in the art.

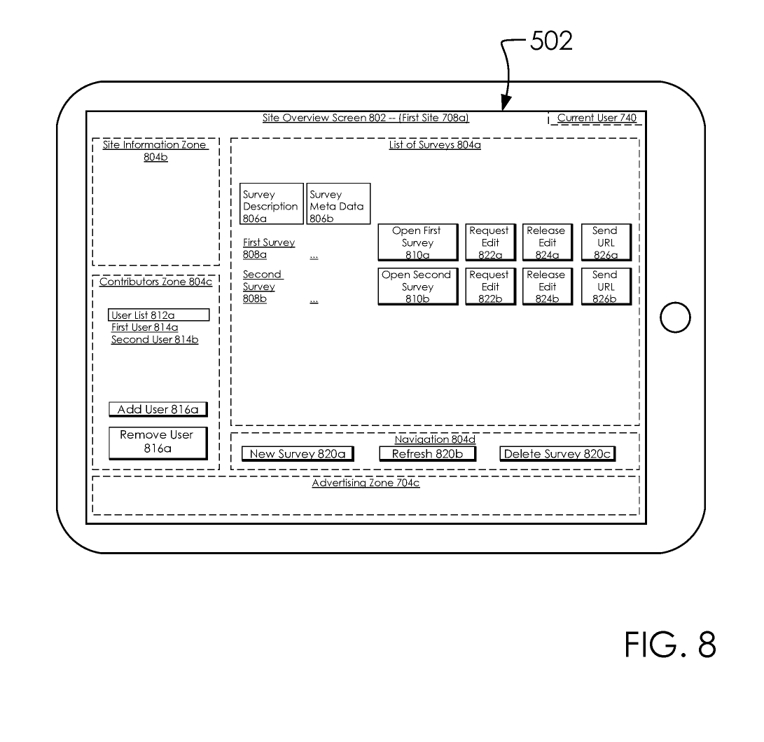

FIG. 8 illustrates UI view of a site overview screen 802.

Said site overview screen 802 can display information about one among said one or more sites 708 from said list of sites screen 702. In one embodiment, each among said one or more sites 708 can comprise one or more traits which are of importance to said current user 740 and/or other users of said device application 502.

Said site overview screen 802 can comprise a one or more lists 804 (which can comprise a surveys list 804a, a site information list 804b, a contributors list 804c, and a navigation list 804d). In one embodiment, said surveys list 804a can comprise a table of surveys having been conducted within said one or more sites 708. Said surveys list 804a can comprise a one or more columns 806 (which can comprise a survey description column 806a and a survey meta data column 806b). In one embodiment, said one or more columns 806 can comprise data fields. Said survey description column 806a can summarize a one or more surveys 808 (which can comprise a first survey 808a and a second survey 808b). said surveys list 804a can further comprise a one or more open survey buttons 810 (which can comprise an open first survey button 810a and an open second survey button 810b), as illustrated. Additional functions available to the user include the ability to seize edit privileges for data, thereby preventing others from modifying the same data, release edit privileges for data, thereby making these privileges available to other users. Using one or more send URL buttons 826, the user may also email a link to system web address to allow the recipient to view the information without being a recognized user of the system.

In one embodiment, said site information list 804b can comprise information related to said one or more sites 708 being edited with said site overview screen 802, for example said first site 708a as illustrated.

In one embodiment, said contributors list 804c can comprise a list of users on said device application 502 with access to and editing rights (of various permission levels) for said one or more sites 708. For example, said contributors list 804c comprises a user list 812a which comprises a one or more users 814 (comprising a first user 814a and a second user 814b). In one embodiment, said contributors list 804c can further comprise an add user button 816a and a remove user button 816b, as is known in the art.

Said navigation list 804d can comprise a navigation buttons 820 (which can comprise a new survey button 820a, a refresh button 820b, and a delete survey button 820c). said new survey button 820a can create a new survey among said one or more surveys 808; said refresh button 820b can refresh data on said site overview screen 802; and said delete survey button 820c can delete one or more among said one or more surveys 808.

As discussed above, said site overview screen 802 can comprise said advertising zone 704c with similar attributes as when placed on said list of sites screen 702.

Said surveys list 804a can comprise a one or more request edit buttons 822 (which can comprise a first request edit button 822a and second request edit button 822b), a one or more release edit buttons 824 (which can comprise a first release edit button 824a and a second release edit button 824b), and a one or more send URL buttons 826 (which can comprise a first send URL button 826a and a second send URL button 826b). In one embodiment, said device application 502 can track a current editor of a survey, lock out some surveys for one or more users and otherwise protect data records stored in said data storage 110 (or other cloud service as known). Said one or more request edit buttons 822 can request editing rights for one or more of said one or more surveys 808, said one or more release edit buttons 824 can release editing of said one or more of said one or more surveys 808, and said one or more send URL buttons 826 can create and send a link to a record for sharing, as is known in the art.

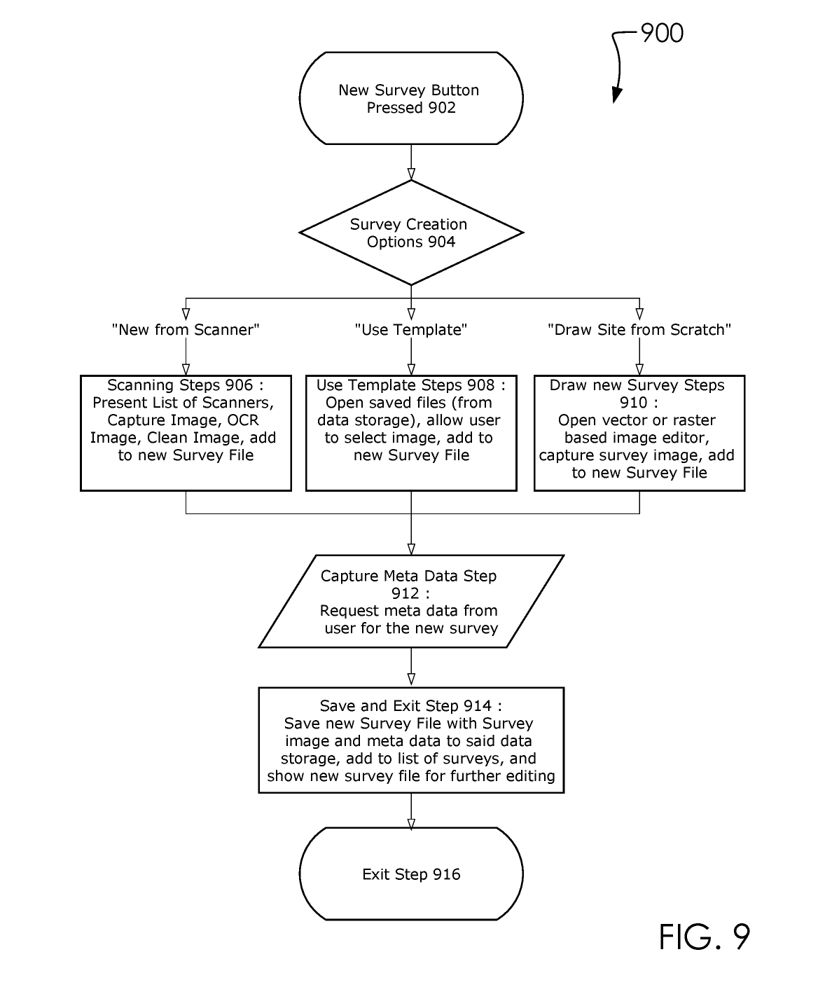

FIG. 9 illustrates a view of a new survey flow chart 900.

In one embodiment, said new survey flow chart 900 can comprise said new survey button pressed step 902, said survey creation options 904, said scanning steps 906, said use template steps 908, said draw new survey steps 910, said capture meta data step 912, said save and exit step 914 and said exit procedure step 916.

Said new survey procedure 900 can be engaged (so as to start at said new survey button pressed step 902) within said device application 502 when a user (such as said current user 740) clicks on said new survey button 820a.

From said new survey button pressed step 902 said device application 502 present said current user 740 with three or more options such as (1) “new from scanner”, (2) “use template” and/or (3) “draw site from scratch”, which are represented with choice step of said survey creation options 904. Here, said current user 740 can be deciding how to create a floor plan or layout of a site. For example, in one embodiment, a new building's floor plan can be entered into said device application 502 by taking a picture of or scanning a print out (option 1, summarized with said scanning steps 906), by using a template of a similar site (option 2, summarized with said use template steps 908), or by drawing a vector or raster image from scratch (option 3, summarized with said draw new survey steps 910). Said use template steps 908 can populate said template from an internal or external image or template source which can be stored in said data storage 110 and/or said data storage 110a.

Said scanning steps 906 can comprise presenting said current user 740 with a list of scanners (which may include the camera of a mobile device, a network scanner, an all-in-one printer/scanner, a fax machine, or similar), allowing said current user 740 to select one or more among said list of scanners, capturing a one or more images with the scanner and storing said one or more images with said device application 502. Said device application 502 can then go about running an OCR on said one or more images to as to identify text, symbols, walls, location features and similar for use within said device application 502. Although “OCR” generally means searching an image for text, in this case, it also includes finding symbols. For example, some existing site surveys comprise symbols to indicate hallways, offices, entrances, exits, equipment installed at the site (such as security equipment). In one case, said new survey procedure 900 may replace symbols in a scan with containers as discussed below. Said scanning steps 906 may further comprise reducing scanned images into clean images (such as vector based images) so that said device application 502 can display an image without pixilation at different levels of zoom. Accordingly, once said scanning steps 906 is completed a new survey file can be added to said one or more surveys 808 and said new survey procedure 900 can move on to said capture meta data step 912, as discussed below.

In one embodiment, said use template steps 908 can comprise opening a saved file (that is a template file) which can comprise a formerly created survey among said one or more surveys 808. Said saved file can comprise a file in said data storage 110 and/or said data storage 110a. Wherein, said current user 740 can select a survey within that old file and adding it to the current file. This step is useful in cases where, for example, a building or site has many repeating features such as floors within a building which repeat one another. After said use template steps 908 is complete, said new survey procedure 900 can move on to said capture meta data step 912, as discussed below.

Said draw new survey steps 910 can comprise opening a vector or raster based image editor to create a site survey map, capturing that image and adding it to a new survey file. In one embodiment, such images may be layered to as to distinguish between different features of the survey, as is known in the art.

In one embodiment, any among said scanning steps 906, said use template steps 908 or said draw new survey steps 910 can begin with a raster image (such as JPG, PNG, GIF, PDF or similar) or a vector image (such as DWG, PDF, or similar); wherein, the steps can use the images as a replacement for a scan, a template of as a starting point for a drawing, respectively.

In one embodiment, said capture meta data step 912 can comprise requesting meta data related to a site from the user, fetching such data from a public or private source, or copying such data from other surveys or templates, as is known in the art.

In one embodiment, said save and exit step 914 can comprise saving a new survey file which can comprise images, meta data, and similar structured data. Wherein, said new survey file can be added to said one or more surveys 808 for review, editing and record keeping, as is known in the art. Then said survey file may be copied to data storage 110 and/or said data storage 110a to be access and retrieved by other users.

Said exit procedure step 916 can close said new survey procedure 900.

In one embodiment, said scanning steps 906 and/or said use template steps 908 can comprise method for acquiring a document or image as a background for an electronic drawing by using an existing photo or device camera to capture an image and apply as a floor plan.

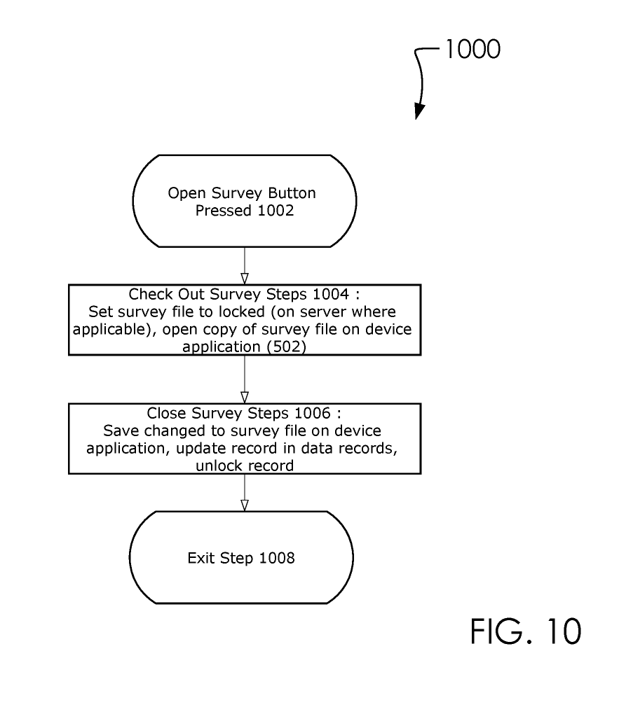

FIG. 10 illustrates a view of an open survey flow chart 1000.

Said open survey procedure 1000 can comprise an open survey button pressed step 1002, a check out survey steps 1004, a close survey steps 1006 and an exit step 1008.

Said check out survey steps 1004 can comprise locking a file for editing by said current user 740, moving a copy of said survey file to said device application 502 from a server or from wherever said one or more surveys 808 are stored.

Once editing or review is complete, said current user 740 can close said survey with said close survey steps 1006, as is known in the art. Wherein, said open survey procedure is completed with said exit procedure step 1008.

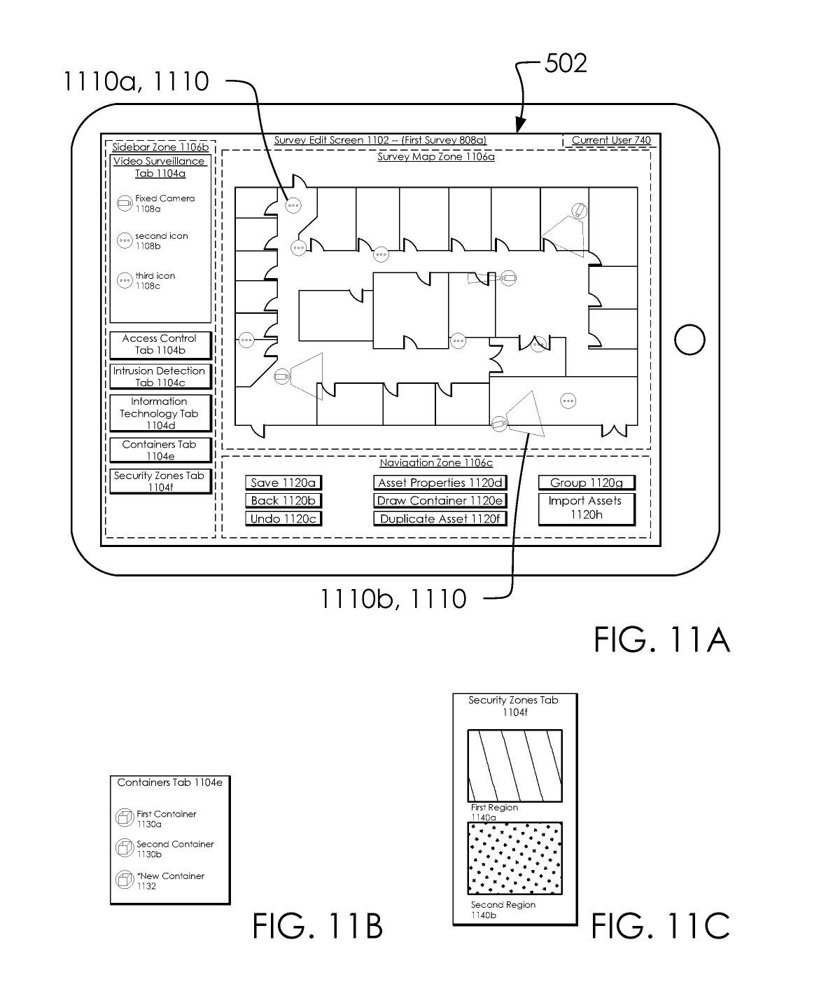

FIG. 11A illustrates UI view of a survey edit screen 1102.

FIG. 11B illustrates UI view of a containers devices 1104e.

FIG. 11C illustrates UI view of a security zones devices 1104f.

In one embodiment, said one or more containers 1130 can comprise said new container 1132.

In one embodiment, said survey edit screen 1102 can comprise a one or more zones 1106 (which can comprise a survey map 1106a, a sidebar zone 1106b, and a navigation zone 1106c).

In one embodiment, said survey map 1106a can comprise a view of a survey map of a portion of a site. For example, as illustrated, said survey map 1106a displays a floor plan of a building having a one or more icons laid thereupon, as discussed below.

Said sidebar zone 1106b can comprise a one or more tool tabs 1104 (which can comprise a video surveillance devices 1104a, an access control devices 1104b, an intrusion detection devices 1104c, an information technology devices 1104d, a containers devices 1104e and a security regions tab 1104f). In one embodiment, said video surveillance devices 1104a can comprise a one or more icons 1108 (which can comprise a first icon 1108a, a second icon 1108b and a third icon 1108c). In one embodiment, said one or more icons 1108 can be dragged and dropped onto said survey map 1106a. In one embodiment, each among said first icon 1108a can comprise a one or more attributes which can be edited by said current user 740, as discussed below.

In one embodiment, said access control devices 1104b can comprise a one or more tools for limiting a person's physical access to various areas represented on said one or more zones 1106, such as ID readers at access doors or similar.

In one embodiment, said intrusion detection devices 1104c can comprise a one or more tools for setting up intrusion alarms at a site, as is known in the art.

In one embodiment, said information technology devices 1104d can comprise a one or more tools for setting up IT assets such as networks, workstations, servers, phone systems, fire alarm, audio-visual, intercom, HVAC, plumbing, electrical, or similar, as is known in the art.

In one embodiment, said containers devices 1104e can comprise a one or more tools for creating groupings and settings related to two or more among said one or more icons 1108 as discussed below.

Likewise, said security regions tab 1104f can comprise a one or more tools for laying out security zones within said survey map 1106a and said first survey 808a generally, as discussed below. Said security zones comprise a layer to the drawing for designating areas as public, semi-secure, secure and so on, as is known in the art.

Said one or more navigation buttons 1120 can comprise a save button 1120a for saving a file, a back button 1120b for backing up from a survey, and an undo button 1120c for undoing an action, as is known in the art. Further, said one or more navigation buttons 1120 can comprise an asset properties button 1120d for editing an asset (such as one among said one or more icons 1108 on said survey map 1106a), where said current user 740 may select said one or more icons 1108 the press said asset properties button 1120d or otherwise double click/tap said one or more icons 1108 to bring up a settings screen, as is known in the art.

Said draw container button 1120e can create a new container for holding two or more among said one or more icons 1108 or other settings from said survey map 1106a.

Said duplicate asset button 1120f can be used to duplicate an asset on said survey map 1106a. said group button 1120g can be used to create a grouping of assets and/or icons, as is known in the art. Finally, said import assets button 1120h can be used to import a binary file containing one or more assets having one or more features and attributes.

In one embodiment, said survey map 1106a can comprise a one or more placed icons 1110 (which can comprise a first placed icon 1110a and a second placed icon 1110b), as illustrated.

Turning to FIGS. 11B-11C:

Said containers devices 1104e can comprise a one or more containers 1130 (which can comprise a first container 1130a and a second container 1130b and a new container 1132). In one embodiment, said containers devices 1104e can be used to create groupings of settings, assets and said one or more icons 1108 for reuse within said device application 502. For example, said first container 1130a can comprise a one or more among said one or more icons 1108 and settings from others among said one or more tool tabs 1104. In one embodiment, said new container 1132 can comprise a target for dragging one or more among said one or more icons 1108 into in order to create a new container automatically through the drag-and-drop UI, as is known in the art. Said one or more containers 1130 can be reused by tapping the icons within said containers devices 1104e or, otherwise, by dragging the same out onto said survey map 1106a.

Said security regions tab 1104f can comprise a one or more regions 1140 such as a first region 1140a and a second region 1140b. In one embodiment, said one or more regions 1140 can indicate various levels of security alarm such as secure, non-secure, semi-secure, and so on. In one embodiment, said one or more regions 1140 can be dragged and dropped onto said survey map 1106a, reshaped and formed to correspond to desired zones, as is known in the art.

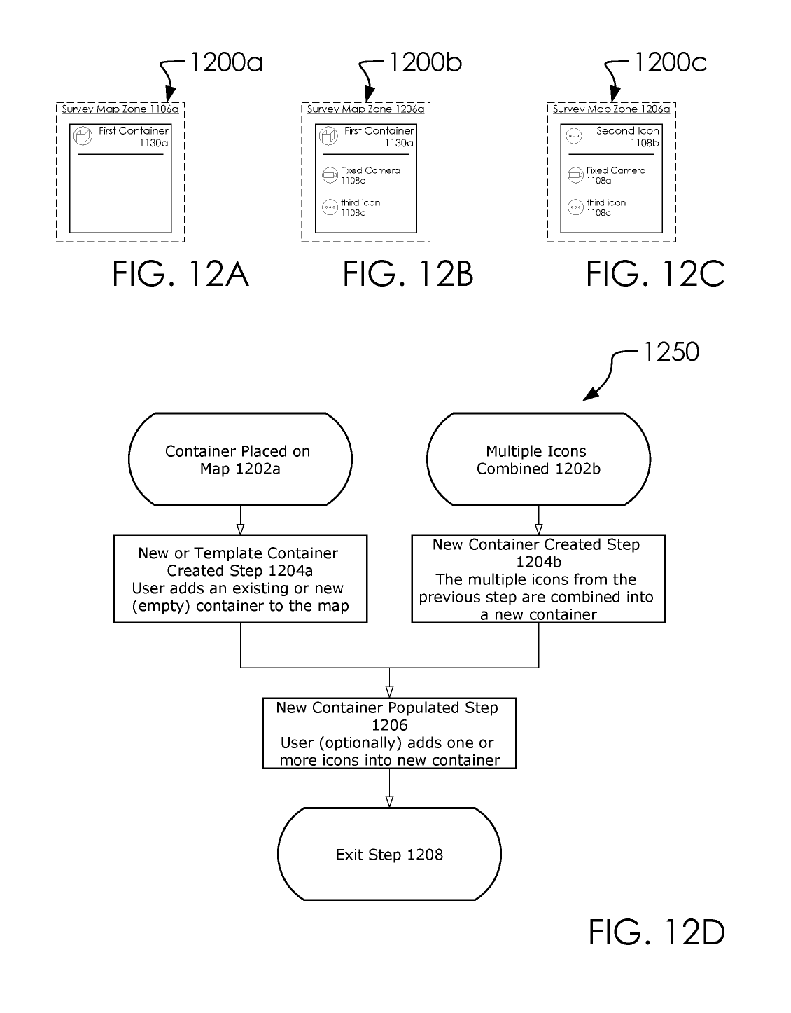

FIG. 12A illustrates a view of an empty container example 1200a.

FIG. 12B illustrates a view of a filling a new container example 1200b.

FIG. 12C illustrates a view of a combing multiple icons example 1200c.

FIG. 12D illustrates a flow chart view of a container creation procedure 1250.

Said empty container example 1200a can comprise a portion of a view of said survey map 1106a with said first container 1130a (that is an existing container) having been dragged thereto. Said first container 1130a can be prepopulated with one or more of said one or more icons 1108 or can be empty, as illustrated. For example, said filling a new container example 1200b can be said first container 1130a with two among said one or more icons 1108 already therein. Alternatively, said combing multiple icons example 1200c can be a circumstance where one among said one or more icons 1108 can be combined with others among said one or more icons 1108 to form a container in ad hoc manner (such as by dragging one icon on top of another). Said one or more icons 1108 applied can disappear from the survey map zone and be logically associated with the container.

Said container creation procedure 1250 can comprise a container placed on map step 1202a, a multiple icons combined step 1202b, a new or template container created step 1204a, a new container created step 1204b, a new container populated step 1206, and an exit procedure step 1208.

Said container placed on map step 1202a can comprise a step where said current user 740 places a container on said survey map 1106a, and drags a one or more assets and/or icons into said container. Said new container populated step 1206 can comprise creating a data relationship between assets and creating a new item on said one or more containers 1130, as disclosed herein.

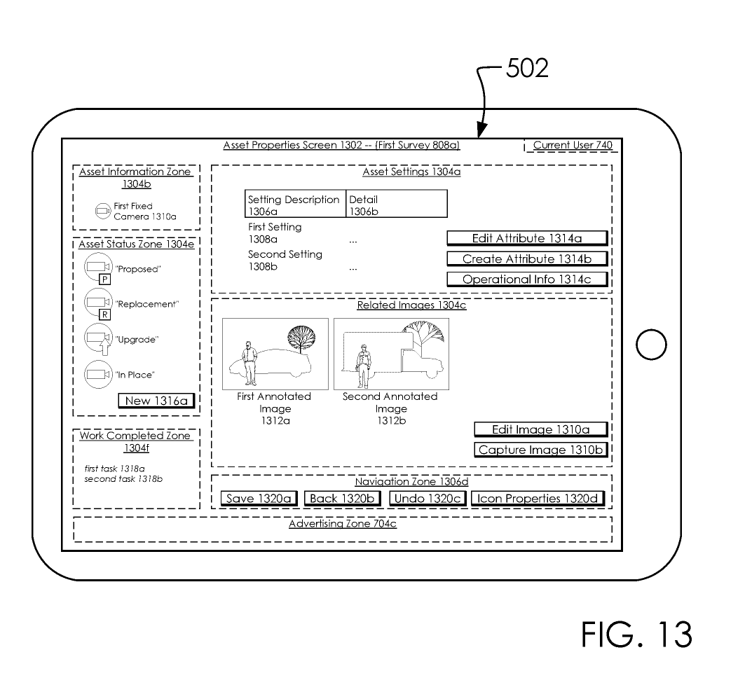

FIG. 13 illustrates UI view of an asset properties screen 1302.

Said asset properties screen 1302 can comprise a one or more zones 1304 (which can comprise an asset settings 1304a, an asset information 1304b, asset images 1304c, a navigation zone 1304d, an asset status 1304e, and a work completed zone 1304f).

Said asset settings 1304a can comprise a table comprising a one or more columns 1306 (which can comprise a setting description column 1306a and a detail column 1306b). Wherein, said setting description column 1306a can summarize a one or more settings 1308 (which can comprise a first setting 1308a and a second setting 1308b). Said one or more settings 1308 can comprise data related to an asset such as maintenance dates, IP addresses, settings, locations, dates of installation and expiration, responsible parties, links to other related assets, or similar. Likewise, said asset settings 1304a can comprise an edit attribute button 1314a (used for editing one or more among said one or more settings 1308) and a create attribute button 1314b (for creating new settings/attributes).

In one embodiment, said operational info button 1314c can allow the user to view and interact with real time operational interface of the device or a third party source with information pertaining to the device.

Said asset information 1304b can comprise a one or more settings related to a current asset (here said edit image button 1310a). Said asset status 1304e can comprise a one or more icons and status settings for a current asset related to a condition of that asset. For example, in one embodiment, said asset can be flagged as being “proposed”, “replacement”, “upgrade”, and/or “in place”, as illustrated. In one embodiment, a new status and/or icon can be created by pressing a new status button 1316. asset properties screen 1302 can be editing a container which can be an asset as well.

In one embodiment, said work completed zone 1304f can comprise a one or more previous tasks 1318 (which can comprise a first task 1318a and a second task 1318b).

Said asset images 1304c can comprise a one or more images 1312 being related to said current asset. In one embodiment, said one or more images 1312 can comprise annotated and non-annotated images. In one embodiment, said edit image button 1310a can be used to edit one or more among said one or more images 1312, and said capture image button 1310b can be used to capture an image (such as with a camera or binary file).

In one embodiment, said memory 306d can comprise a one or more navigation buttons 1320 (which can comprise a save button 1320a, a back button 1320b, an undo button 1320c and an icon properties button 1320d). In one embodiment, said save button 1320a can save a record; said back button 1320b can comprise a navigation command; said undo button 1320c can comprise an undo command; and said icon properties button 1320d can open a one or more properties for an icon.

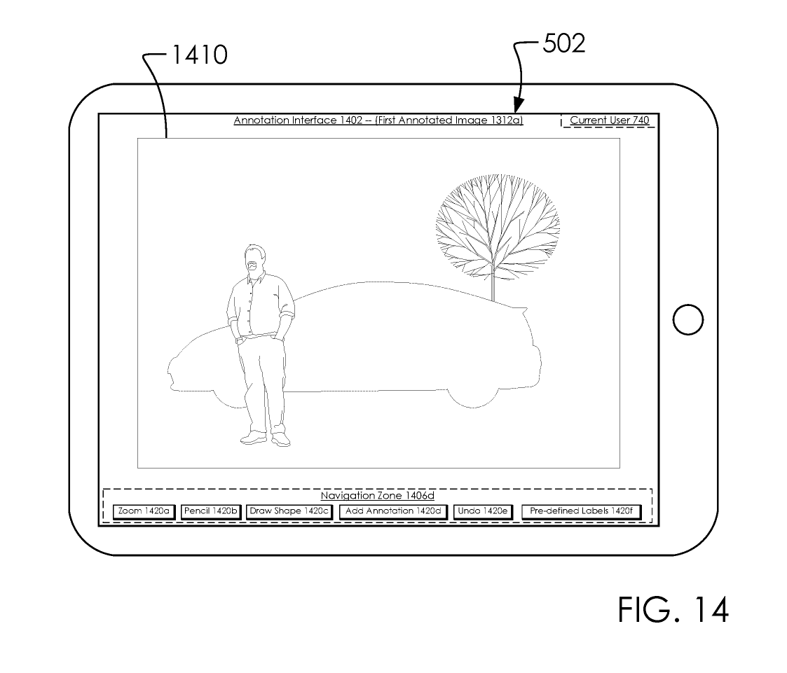

FIG. 14 illustrates UI view of an annotation interface 1402.

In one embodiment, said annotation interface 1402 can comprise said one or more navigation buttons 1420.

In one embodiment, said one or more navigation buttons 1420 can comprise said zoom button 1420a, said pencil button 1420b, said draw shape button 1420c, said add annotation button 1420d, said undo button 1420e and said pre-defined labels button 1420f.

Said annotation interface 1402 can comprise a displayed image 1410. Wherein, said displayed image 1410 can be annotated with a one or more commands in a navigation zone 1406d (which e comprise a one or more navigation buttons 1420). In one embodiment, said one or more navigation buttons 1420 can comprise a zoom button 1420a, a pencil button 1420b, a draw shape button 1420c, an add annotation button 1420d, an undo button 1420e and a pre-defined labels button 1420f, as is known in the art.

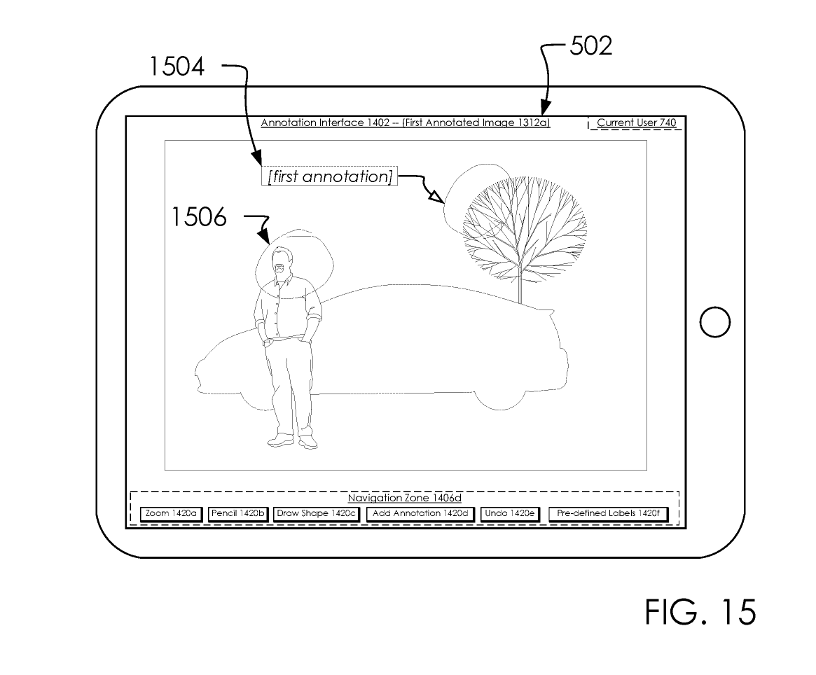

FIG. 15 illustrates UI view of an annotation interface 1402.

In one embodiment, said displayed image 1410 can be annotated with a first typed annotation 1504 and a first drawn annotation 1506 as shown.

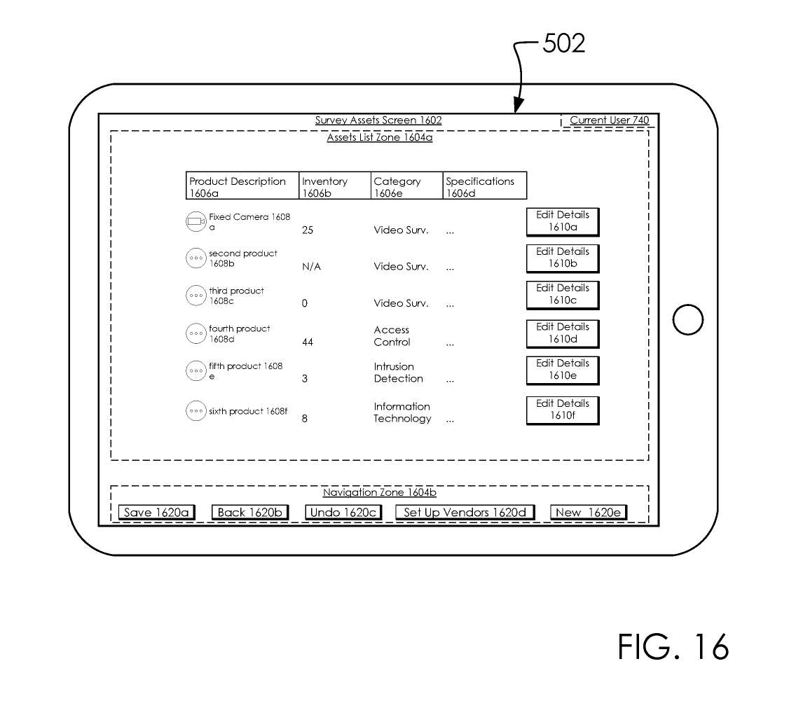

FIG. 16 illustrates UI view of a survey assets screen 1602.

In one embodiment, said one or more buttons 1620 can comprise said save button 1620a, said back button 1620b, said undo button 1620c, said set up vendors button 1620d and said new button 1620e.

In one embodiment, survey assets screen 1602 can comprise an assets list 1604a and a navigation zone 1604b. In one embodiment, said assets list 1604a can comprise a one or more columns 1606 (which can comprise a product description column 1606a, an inventory column 1606b, an order delay column 1606c, a specifications column 1606d, a generic flag column 1606f, and/or a category column 1606e). Said order delay column 1606c and said generic flag column 1606f are not illustrated but can be used in some embodiments. In one embodiment, said product description column 1606a can comprise a one or more products 1608 (such as a fixed camera 1608a, a second product 1608b, a third product 1608c, a fourth product 1608d, a fifth product 1608e and a sixth product 1608f). In one embodiment, said inventory column 1606b can comprise a summary of an inventory for each item in said one or more products 1608. Said category column 1606e can comprise a category for each among said one or more products 1608. In one embodiment, a one or more edit details buttons 1610 (such as 1610a-1610f), can open a details editing screen for each among said one or more products 1608.

Said navigation zone 1604b can comprise a one or more buttons 1620.

Said one or more columns 1606 can comprise more technical details such as manufacturer's number, camera specs, etc.

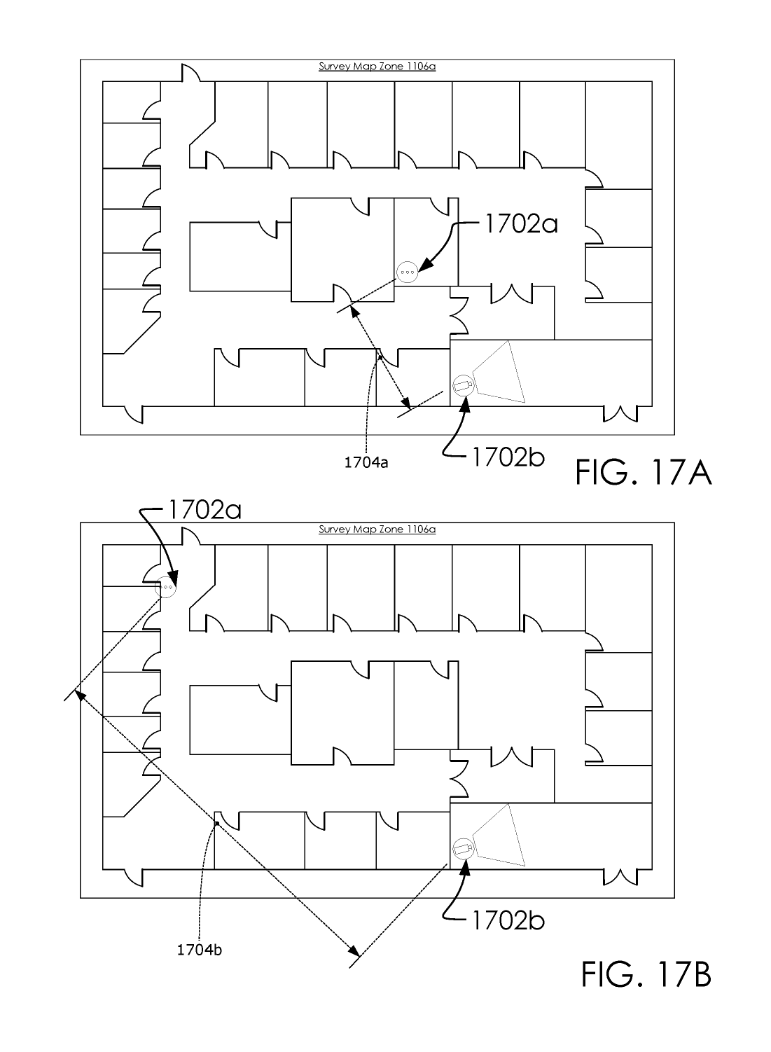

FIG. 17A illustrates a first UI view of a survey map 1106a.

FIG. 17B illustrates a second UI view of a survey map 1106a.

In one embodiment, said asset relationship 1720 can comprise said first asset relationship 1720a.

In one embodiment, said plurality of icons 1702 can comprise said first icon 1702a, said second icon 1702b, said camera icon 1702c and said camera icon 1702c.

In one embodiment, said camera icon 1702c can comprise said camera icon 1702c.

In one embodiment, said device application 502 can group said one or more icons 1108 into an asset relationship 1720 (not illustrated). For example, herein said one or more icons 1108 can comprise a first icon 1702a and a second icon 1702b; wherein, the icons are a first distance 1704a apart before a move and a second distance 1704b after a move. Said device application 502 can track changed between assets such as distances there-between. For example, while at said first distance 1704a the illustrated icons may have a common feature together and after being moved to said second distance 1704b they may lose that common feature or data setting.

This may come in helpful when setting up a site map quickly. For example, when two assets are in the same room on a site map, then it can be inferred by the placement that they are in the same security zone, that they may have similar data security settings, similar recording settings, on/off schedules, or nomenclature. Additionally, relocation of an asset may alter embedded error checking algorithms or system calculations such as electrical, HVAC or network loading as well as the inventory of physical interfaces of the associated assets. similar.

For example, if a first icon is initially in a lobby where the technician has taken photos of the location and set up attributes, if the client changes his mind and moves it to a work room, now said device application 502 can change the location name and the description of the camera from “lobby camera 1” to “workroom camera 3” and can remove or archive annotated images at that time. Note that the attributes of the hardware are not changed, only the meta data and setting specific data as described and implied herein.

For example, moving the camera from floor 2 to floor 3. We would have similar setting and attributes, but restricted to that floor and survey.

Note that on a change some settings may be returned to a default setting.

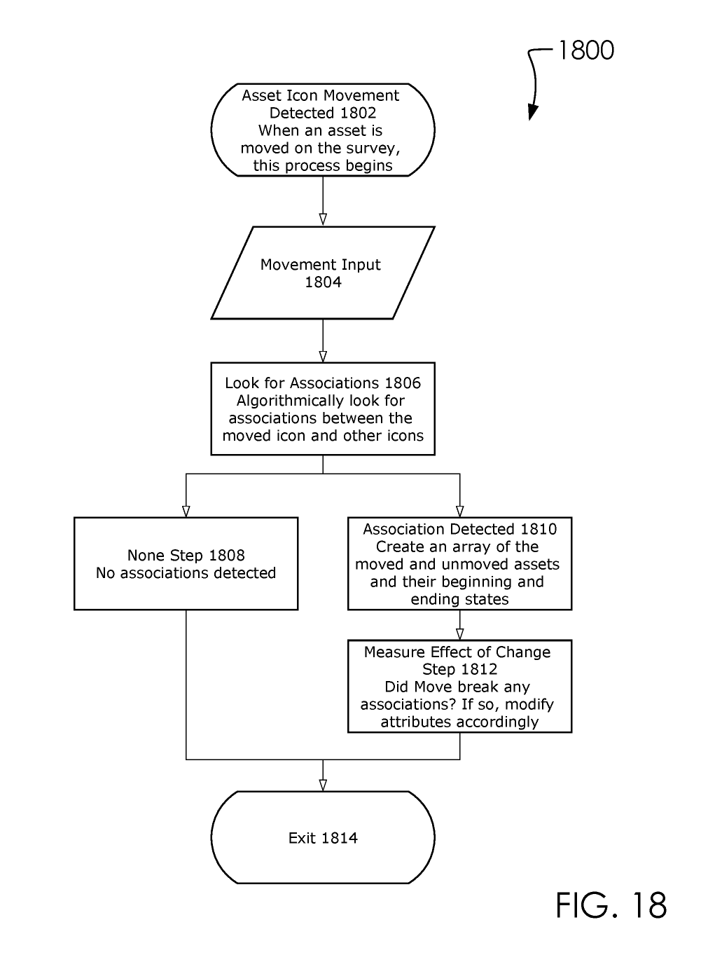

FIG. 18 illustrates a flow chart view of an asset icon movement detected procedure 1800.

In one embodiment, said asset icon movement detected procedure 1800 can comprise said asset icon movement detected step 1802, said movement input step 1804, said look for associations step 1806, said no associations found step 1808, said associations found step 1810, said measure effect of change step 1812 and said exit procedure step 1814.

Said asset icon movement detected step 1802 can comprise a trigger in said device application 502 where two associated icons are moved or where one icon is moved from one setting to another where certain settings for that icon are location dependent.

Said asset icon movement detected procedure 1800 requires that said movement input step 1804 be detected or that an association with another asset be broken by moving the other asset way from the current asset.

Said look for associations step 1806 can comprise a step of looking for associations between the current asset and the location change or the broken association with other assets. If none are found, the process goes to said no associations found step 1808. Otherwise, it goes to said associations found step 1810.

Said associations found step 1810 find the changes in the asset(s) and passes an array of those changed to said measure effect of change step 1812.

Said measure effect of change step 1812 triggers changes to those affected assets after the move.

Finally, said asset icon movement detected procedure 1800 exits with said exit procedure step 1814.

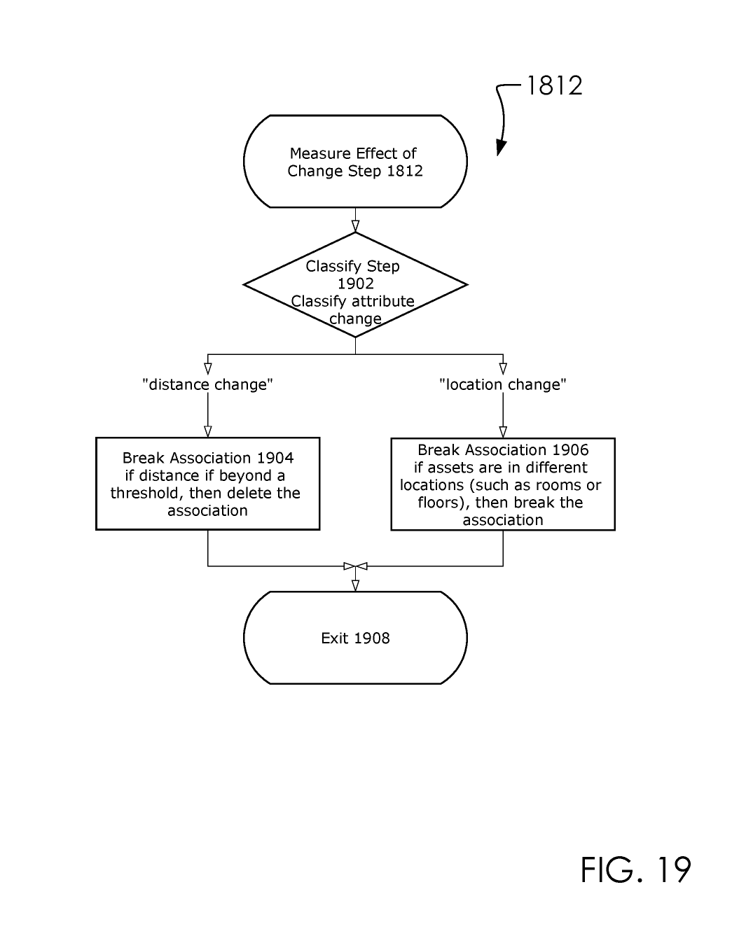

FIG. 19 illustrates a flow chart view of a measure effect of change step 1812.

In one embodiment, said measure effect of change step 1812 can comprise said classify step 1902, said break association step 1904, said break association step 1906 and said exit procedure step 1908.

Said classify step 1902 classifies the change as a change in distance, classification, or similar. Two examples are given as “distance change” and/or “location change”. Where the change is a “distance change”, said measure effect of change step 1812 will use said break association step 1904 (in some cases), provide the distance is great enough. If the change is a “location change”, said measure effect of change step 1812 will use said break association step 1906 to break the association, as described herein. Finally, said measure effect of change step 1812 exits with said exit procedure step 1908.

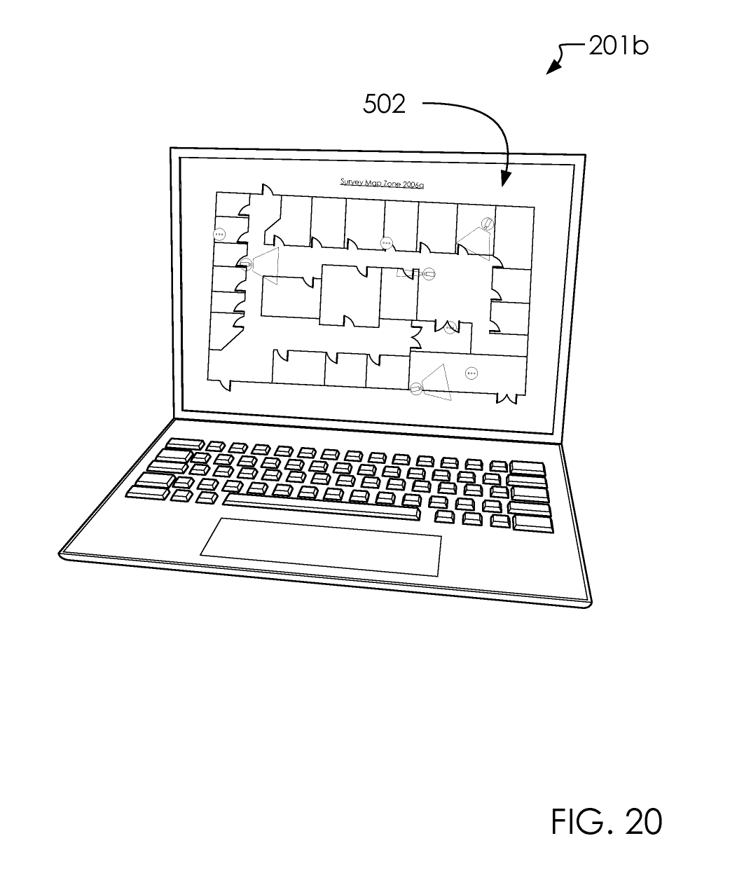

FIG. 20 illustrates a perspective overview view of a personal computer 201b.

In one embodiment, said device application 502 can comprise a local program being installed on a local machine, a web app hosted on a server and accessed through a web browser, or an app on a smart device.

Additional disclosures related to said site diagram system 100 follow.

Said device application 502 can comprise a method for accumulation of data including element specific attributes in a single interface with predefined selection options, photos with an annotation tool as well as capture user defined configuration and operational details.

Said device application 502 can comprise the ability for users to refresh available attribute characteristics and options on demand to retrieve the latest available of said one or more icons 1108 and said one or more settings 1308 without having to upgrade the application itself

Said device application 502 can comprise the ability to accommodate third party utilities within a drawing program providing two-way interaction or additional functionality. This interaction could modify the presentation or animation of the visual element as indicated by said operational info button 1314c.

Said device application 502 can comprise the ability to collaborate among a common group of users by the sharing user determining edit privileges of the recipient of the information sharing.

Said device application 502 can comprise a centralized database or library with folder structure containing site specific information available to a restricted set of users who can “Check out” the information to view, modify or replace information.

Said device application 502 can comprise an information retrieval mechanism that will automatically retrieve or rescind edit rights to information contained on a connected device based upon automated or administrative action such as a timer or user account status.

Said device application 502 can comprise the ability to collect user data and compare the data set to a product catalog which will perform an algorithm to determine the quality of a match against eligible products.

Said device application 502 can comprise a construction of a database made available to product manufacturers to collect information to populate and index a reference database which can then be searched and filtered for the user to present a selection of products most closely matching information contained in the Asset Settings 1304a.

Said device application 502 can comprise the ability to create dynamic logical groups by associating elements together. This would include cable path associations to create eligible connection groups These logical groups would also facilitate certain capacity calculations and data validation

Said device application 502 can comprise the ability to generate a network diagram based upon retrieval of technical characteristics of an item and user defined associations among components.

Said device application 502 can comprise the ability to import an asset list and automatically create graphical icons to be placed on an electronic drawing.

Said device application 502 can comprise the ability to allow users to create custom attributes on a web based platform and transferred to a mobile tablet that could then be applied to an electronic drawing.

Said device application 502 can comprise the ability to target content such as said advertising zone 704c to said current user 740 based upon a user's interaction with or input to said device application 502.

Said device application 502 can comprise the aggregation of user data to provide broader statistical data related to market demand.

Said device application 502 can comprise the use of GPS to locate an element on an electronic drawing and retrieve data about that element which can be viewed, changed or deleted by the user. For example, in one embodiment, a user can capture data with the GPS running and catching geo-data automatically for easy use later.

Said device application 502 can comprise the organization of user accounts within an application by “workbench” structure allowing a user to easily switch between multiple accounts on the same application without the need to use multiple log in credentials.

Said device application 502 can comprise the ability to duplicate an element (such as with said duplicate asset button 1120f) but removing unique information that should not be duplicated.

Said device application 502 can comprise the ability to consolidate data fields based on element associations. When an element is dropped into a container the data fields of location and description are linked and suppressed. For example, use of a mater-slave data relationship between assets. This is helpful when grouping assets and ensuring that the group can share attributes which apply to all in the group, such as room name, etc. For example, consider access control system: four components for related parts are physically and logically linked to one another and should therefore have linked specification and attribute fields. In this way attributes are shared and accessible through a central control panel. For example, a “5 second unlock command” is handled in the control panel and the door unlock mechanism.

Said device application 502 can comprise the ability to use a “containers” icon (such as one or more containers 1130) on an electronic drawing which allows other icons to be dropped “inside” to indicate a location/geographical or functional association among the embedded elements.

Said device application 502 can comprise the ability to require users to connect to the network in order to continue to use the application and refresh user credentials.

Said device application 502 can comprise the ability to apply labels to photos within an application that have been predefined by the user by selection of a predefined label button 1420f.

Said device application 502 can comprise a utility that references data stored in a product catalog to make certain calculations such as total heat dissipation or power load, or to determine component compatibility.

Said device application 502 can comprise the ability to attach information to an icon for purposes of maintaining record of work completed.

Said device application 502 can comprise the ability to detect when an element is repositioned on the floor plan canvas more than a certain distance the content for the location specific attributes will be reset (see also FIGS. 17A, 17B and 18).

Said device application 502 can comprise the ability for user to search a PDF, JPG or PNG document to optically identify user defined symbols and overlay a user selected icon where the defined symbol was found. The user will have the option to accept or reject the placement.

Said device application 502 can comprise the application of a visual symbol to an icon to represent the installation and operational status of the asset represented by an icon.

Said device application 502 can be used to control access by delegates to site information with the ability to remote wipe a system and/or limit access based on certain conditions, as is known in the art.

Said device application 502 can further comprise the ability to automatically look up equipment specification with the provision of a model number and specification depository such as a website or database.

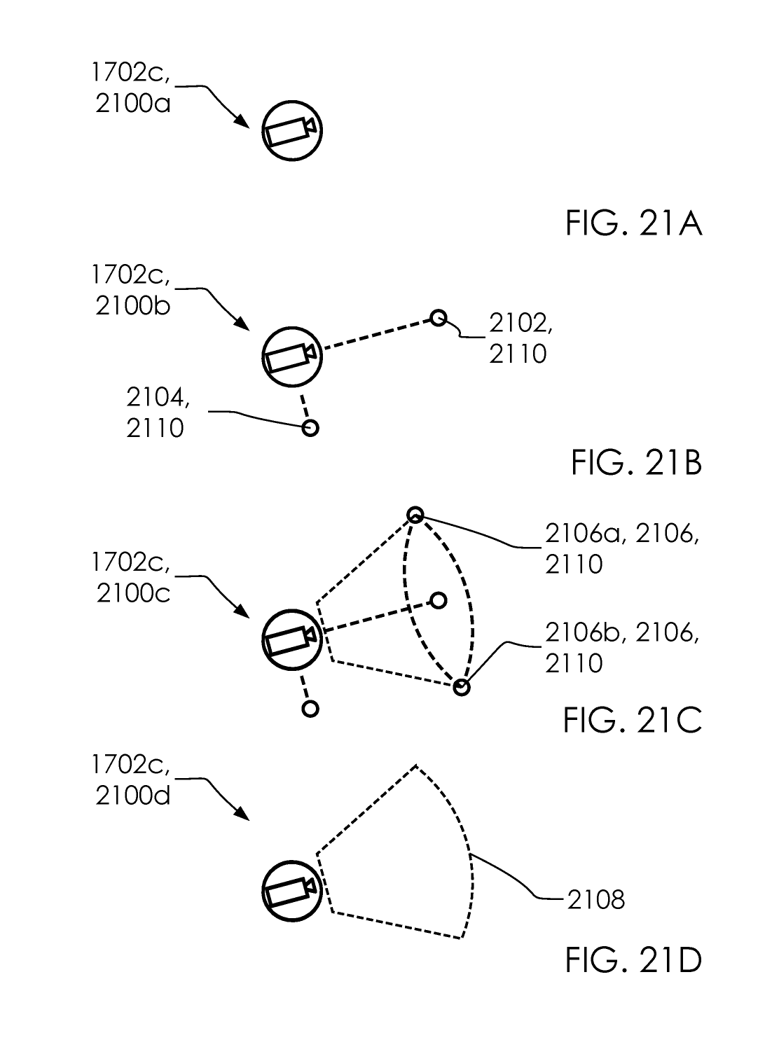

FIG. 21A illustrates UI view of a first configuration 2100a.

FIG. 21B illustrates UI view of a second configuration 2100b.

FIG. 21C illustrates UI view of a third configuration 2100c.

FIG. 21D illustrates UI view of a fourth configuration 2100d.

In one embodiment, said one or more configurations 2100 can comprise said first configuration 2100a, said second configuration 2100b, said third configuration 2100c and said fourth configuration 2100d.

In one embodiment, said one or more width inputs 2106 can comprise said first width input 2106a and said second width input 2106b.

In one embodiment, said depth of field input markers 2110 can comprise said depth input 2102, said angle input 2104, said one or more width inputs 2106, said first width input 2106a, said second width input 2106b and said depth of field indication 2108.

In one embodiment, said camera icon 1702c can comprise said one or more configurations 2100, said depth input 2102, said angle input 2104, said angle input 2104, said one or more width inputs 2106 and said depth of field indication 2108.

In one embodiment, said plurality of icons 1702 (specifically said camera icon 1702c) can comprise UI inputs for setting up said depth of field indication 2108 for each among said camera icon 1702c.

Said first configuration 2100a can comprise said camera icon 1702c without said depth of field indication 2108, that is without any inputs for said depth of field indication 2108 being entered into said device application 502. Said second configuration 2100b can comprise said camera icon 1702c with said depth input 2102 and said angle input 2104 exposed for manipulation. Said third configuration 2100c can comprise said camera icon 1702c with said depth input 2102, said angle input 2104 and said one or more width inputs 2106 exposed. In one embodiment, said plurality of icons 1702 can receive inputs related to said depth input 2102 and/or said angle input 2104 before requesting inputs with said one or more width inputs 2106. Said one or more width inputs 2106 can comprise a range width of visual input into a camera represented by said camera icon 1702c. Finally, said fourth configuration 2100d can comprise said depth of field indication 2108 displayed in a UI of said device application 502, as previously entered.

Accordingly, a user of said device application 502 can place said camera icon 1702c on survey map 1106a, set said depth input 2102, said angle input 2104 and said one or more width inputs 2106 to establish said depth of field indication 2108.

Said depth input 2102 can comprise a distance, at scale with said survey map 1106a or at a specific scale or distance, as is known in the art. Said one or more input devices 204 can comprise an angle between 0 and 360 degrees (or similar coordinate systems, as is known in the art). Said one or more width inputs 2106 can comprise an angle, stored as a number, similar to said angle input 2104. Said angle input 2104 can comprise an angle of said camera icon 1702c relative to a predetermined 0 degree angle of said survey map 1106a such as from left to right on the page. Said one or more width inputs 2106 can comprise an angle between said first width input 2106a and said second width input 2106b.

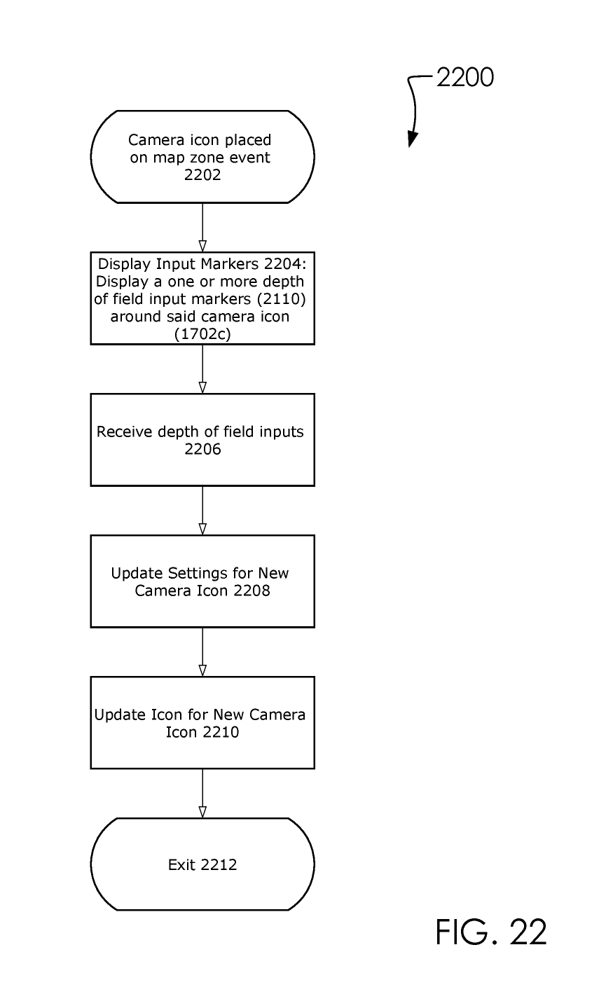

FIG. 22 illustrates a view of a new camera icon set up flow chart 2200.

In one embodiment, said new camera icon set up flow chart 2200 can comprise said camera icon placed on map event 2202, said display input markers event 2204, said receive depth of field inputs step 2206, said update settings for new camera icon step 2208, said update icon for new camera icon step 2210 and said exit step 2212.

Said one or more configurations 2100 as illustrated in FIGS. 21A-21D can be further explained with said new camera icon set up flow chart 2200.

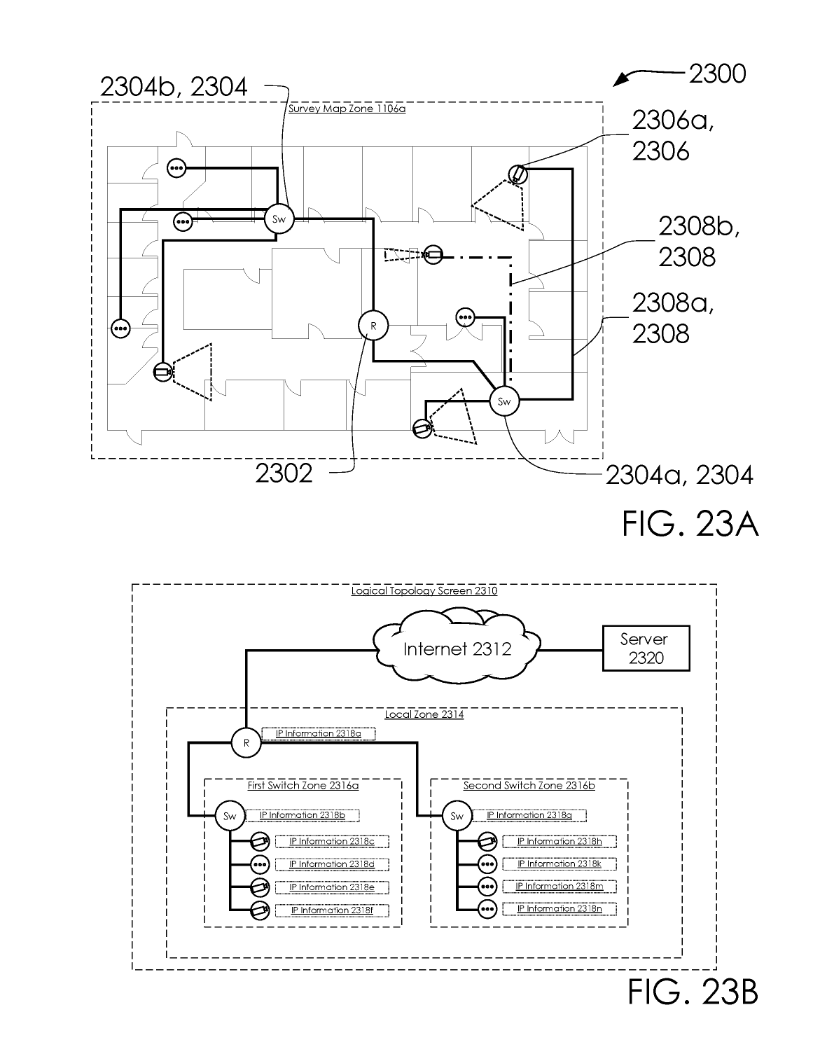

FIG. 23A illustrates UI view of a physical topology screen 2300.

FIG. 23B illustrates UI view of a logical topology screen 2310.

In one embodiment, said physical topology screen 2300 can comprise said one or more routers 2302, said one or more switch-gateways 2304, said one or more networked devices 2306, said one or more connection lines 2308 and said eleventh IP information 2318n.

In one embodiment, said one or more routers 2302 can comprise said first router 2302a and said second router 2302b.

In one embodiment, said one or more switch-gateways 2304 can comprise said first switch-gateway 2304a and said second switch-gateway 2304b.

In one embodiment, said one or more networked devices 2306 can comprise said first networked device 2306a, said second networked device 2306b, said third networked device 2306c, said fourth networked device 2306d, said fifth networked device 2306e, said sixth networked device 2306f, said seventh networked device 2306g and said eight networked device 2306h.

In one embodiment, said logical topology screen 2310 can comprise said internet icon 2312, said local zone 2314, said one or more switch zones 2316, said one or more IP information 2318 and said remote server 2320.

In one embodiment, said one or more switch zones 2316 can comprise said first switch zone 2316a and said second switch zone 2316b.

In one embodiment, said one or more IP information 2318 can comprise said first IP information 2318a, said second IP information 2318b, said third IP information 2318c, said fourth IP information 2318d, said fifth IP information 2318e, said sixth IP information 2318f, said seventh IP information 2318g, said eight IP information 2318h, said ninth IP information 2318k, said tenth IP information 2318m and said eleventh IP information 2318n.

In one embodiment, said one or more connection lines 2308 can comprise said physical connection line 2308a and said wireless connection line 2308b.

In one embodiment, said survey map 1106a can comprise said physical topology screen 2300, said physical topology screen 2300, said one or more routers 2302, said second router 2302b, said one or more switch-gateways 2304, said second switch-gateway 2304b, said one or more networked devices 2306, said logical topology screen 2310, said internet icon 2312, said local zone 2314, said local zone 2314, said one or more switch zones 2316, said second switch zone 2316b and said one or more IP information 2318.

In one embodiment, said site diagram system 100 can express a portion of said network configuration 112 and/or a portion of a physical topology screen 2300 as a physical map of devices on a map with physical or wireless connections between them, or else as said logical topology screen 2310, as illustrated.

In one embodiment, each among said one or more switch-gateways 2304, said one or more networked devices 2306 and said one or more connection lines 2308 can comprise said one or more IP information 2318, as is known in the art. In one embodiment, said site diagram system 100 can track said one or more IP information 2318 for later use. In one embodiment, capturing said one or more IP information 2318 and a one or more locations of items on said physical topology screen 2300 and said logical topology screen 2310 can be done at a time of planning, installation and/or investigating an existing system

The following sentences are included for completeness of this disclosure with reference to the claims. A site diagram system for use by a user for capturing a physical and/or logical layout of a one or more networked devices, to plan a one or more sites or to create a system diagram or a install checklist. said site diagram system comprising a one or more computers. Said one or more computers comprising a processor and a memory. Said processor configured to run a device application. Said device application configured to create said system diagram. Said device application comprises a surveys list comprising a record of a one or more surveys comprising at least a first survey. each among said one or more surveys comprising a data collected by said user concerning a site location. Said one or more surveys comprising a survey map and a one or more placed icons. Said survey map comprising a representation of said site location including floor plans and similar. Said one or more placed icons comprising representations of assets to be placed on said survey map. Said one or more placed icons each comprise an asset settings. Said device application comprises said survey map configured to receive a one or more among said one or more placed icons and to capture said asset settings related to said one or more placed icons. Said one or more placed icons can be grouped together in a one or more containers, wherein, each of said one or more containers comprise a one or more zones related to each of said one or more placed icons within said one or more containers. Said device application is configured to create a new container when said user drags said new container onto said survey map, combine a one or more of said one or more placed icons into said new container, and configuring said asset settings for said new container. Said site diagram system further comprises a physical topology screen and a logical topology screen. Said physical topology screen comprises said one or more networked devices displayed on a one or more zones, and said one or more networked devices connected to one another through a one or more connection lines. Said one or more networked devices comprise computing devices selected among a one or more placed icons, a one or more switch-gateways, and a one or more routers. A device application is configured to capture a networking data related to said one or more networked devices as they are added to a survey map. Said networking data comprises connection types for said one or more connection lines, device types among said one or more networked devices, a one or more IP information for each among said one or more networked devices, and network hierarchy between said one or more switch-gateways and said one or more routers. Said device application is configured to render said logical topology screen from said networking data and said physical topology screen. A one or more placed icons comprise a camera icon. Said camera icon comprise a representation of a video surveillance devices. A device application is configured to capture a depth of field data for said camera icon by receiving said camera icon in a survey map, displaying a depth of field input markers on said camera icon, receiving a depth input, an angle input, and a one or more width inputs with said depth of field input markers, rendering a depth of field indication on said camera icon, and recording said depth of field data for said camera icon. A plurality among a one or more placed icons can be configured into an asset relationship with a device application. Said asset relationship manages a one or more among an asset settings in common between said one or more placed icons in said asset relationship. Said asset relationship can be broken by changes in a status of one or more among said one or more placed icons in said asset relationship. Said plurality of said one or more placed icons in said asset relationship comprise a first placed icon and a second placed icon in a first asset relationship. initially, with said first placed icon and said second placed icon in said first asset relationship, said first placed icon and said second placed icon are separated by a first distance. when said first placed icon and said second placed icon are moved apart from one another to a second distance, said first asset relationship is severed by said device application. Said site diagram system further comprises an assets list related each among a one or more placed icons. Said assets list tracks data and inventory levels related to said one or more placed icons. Said assets list is provided for planning purposes. A one or more placed icons comprise an asset settings, an asset information, a work completed zone and an asset images. Said asset settings comprising attributes of said one or more placed icons. Said asset information comprising information about said one or more placed icons. Said work completed zone comprising a one or more tasks to be followed up on related to said one or more placed icons. Said asset images comprising a one or more images. Said one or more images are related to said one or more placed icons and comprise a annotated image and a unannotated image. A one or more placed icons further comprise a security zones devices, a access control devices and a intrusion detection devices. Said security zones devices are overlaid on a survey map to define secure areas within a site location. Said access control devices and said intrusion detection devices can be configured to protect said security zones devices and create alert signals for access events related to said security zones devices. A one or more placed icons can be grouped together in a one or more containers, wherein, each of said one or more containers comprise a one or more zones related to each of said one or more placed icons within said one or more containers. A device application is configured to create a new container when said user drags said new container onto a survey map, combine a one or more of said one or more placed icons into said new container, and configuring an asset settings for said new container. A one or more placed icons comprise a video surveillance devices, a access control devices, a intrusion detection devices, a information technology devices, and a security zones devices. A site diagram system for use by a user for capturing a physical and/or logical layout of a one or more networked devices, to plan a one or more sites or to create a system diagram or a install checklist. said site diagram system comprising a one or more computers. Said one or more computers comprising a processor and a memory. Said processor configured to run a device application. Said device application configured to create said system diagram. Said device application comprises a surveys list comprising a record of a one or more surveys comprising at least a first survey. each among said one or more surveys comprising a data collected by said user concerning a site location. Said one or more surveys comprising a survey map and a one or more placed icons. Said survey map comprising a representation of said site location including floor plans and similar. Said one or more placed icons comprising representations of assets to be placed on said survey map. Said one or more placed icons each comprise an asset settings. Said device application comprises said survey map configured to receive a one or more among said one or more placed icons and to capture said asset settings related to said one or more placed icons. Said one or more placed icons can be grouped together in a one or more containers, wherein, each of said one or more containers comprise a one or more zones related to each of said one or more placed icons within said one or more containers. Said device application is configured to create a new container when said user drags said new container onto said survey map, combine a one or more of said one or more placed icons into said new container, and configuring said asset settings for said new container. A site diagram system for use by a user for capturing a physical and/or logical layout of a one or more networked devices, to plan a one or more sites or to create a system diagram or a install checklist. said site diagram system comprising a one or more computers. Said one or more computers comprising a processor and a memory. Said processor configured to run a device application. Said device application configured to create said system diagram. Said device application comprises a surveys list comprising a record of a one or more surveys comprising at least a first survey. each among said one or more surveys comprising a data collected by said user concerning a site location. Said one or more surveys comprising a survey map and a one or more placed icons. Said survey map comprising a representation of said site location including floor plans and similar. Said one or more placed icons comprising representations of assets to be placed on said survey map. Said one or more placed icons each comprise an asset settings. Said device application comprises said survey map configured to receive a one or more among said one or more placed icons and to capture said asset settings related to said one or more placed icons. Said one or more placed icons comprise a camera icon. Said camera icon comprise a representation of a video surveillance devices. Said device application is configured to capture a depth of field data for said camera icon by receiving said camera icon in said survey map, displaying a depth of field input markers on said camera icon, receiving a depth input, an angle input, and a one or more width inputs with said depth of field input markers, rendering a depth of field indication on said camera icon, and recording said depth of field data for said camera icon.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A site diagram system for use by a user for capturing a physical and/or logical layout of a one or more networked devices, to plan a one or more sites or to create a system diagram or a install checklist, wherein:
said site diagram system comprising a one or more computers;
said one or more computers comprising a processor and a memory;
said processor configured to run a device application;
said device application configured to create said system diagram;
said device application comprises a surveys list comprising a record of a one or more surveys comprising at least a first survey;
each among said one or more surveys comprising a data collected by said user concerning a site location;
said one or more surveys comprising a survey map and a one or more placed icons;
said survey map comprising a representation of said site location including floor plans and similar;
said one or more placed icons comprising representations of assets to be placed on said survey map;
said one or more placed icons each comprise an asset settings;
said device application comprises said survey map configured to receive a one or more among said one or more placed icons and to capture said asset settings related to said one or more placed icons;
said one or more placed icons can be grouped together in a one or more containers, wherein,
each of said one or more containers comprise a one or more zones related to
each of said one or more placed icons within said one or more containers; and
said device application is configured to
create a new container when said user drags said new container onto said survey map,
combine a one or more of said one or more placed icons into said new container, and
configuring said asset settings for said new container.

2. The site diagram system from claim 1, wherein:
said site diagram system further comprises a physical topology screen and a logical topology screen;
said physical topology screen comprises
said one or more networked devices displayed on a one or more zones, and
said one or more networked devices connected to one another through a one or more connection lines; and
said one or more networked devices comprise computing devices selected among a one or more placed icons, a one or more switch-gateways, and a one or more routers.

3. The site diagram system from claim 2, wherein:
a device application is configured to capture a networking data related to said one or more networked devices as they are added to a survey map.

4. The site diagram system from claim 3, wherein:
said networking data comprises
connection types for said one or more connection lines,
device types among said one or more networked devices,
a one or more IP information for each among said one or more networked devices, and
network hierarchy between said one or more switch-gateways and said one or more routers.

5. The site diagram system from claim 3, wherein:
said device application is configured to render said logical topology screen from said networking data and said physical topology screen.

6. The site diagram system from claim 1, wherein:
a one or more placed icons comprise a camera icon;
said camera icon comprise a representation of a video surveillance devices; and
a device application is configured to capture a depth of field data for said camera icon by
receiving said camera icon in a survey map,
displaying a depth of field input markers on said camera icon,
receiving a depth input, an angle input, and a one or more width inputs with said depth of field input markers,
rendering a depth of field indication on said camera icon, and
recording said depth of field data for said camera icon.

7. The site diagram system from claim 1, wherein:
a plurality among a one or more placed icons can be configured into an asset relationship with a device application;
said asset relationship manages a one or more among an asset settings in common between said one or more placed icons in said asset relationship; and
said asset relationship can be broken by changes in a status of one or more among said one or more placed icons in said asset relationship.

8. The site diagram system from claim 7, wherein:
said plurality of said one or more placed icons in said asset relationship comprise a first placed icon and a second placed icon in a first asset relationship;
initially, with said first placed icon and said second placed icon in said first asset relationship, said first placed icon and said second placed icon are separated by a first distance; and
when said first placed icon and said second placed icon are moved apart from one another to a second distance, said first asset relationship is severed by said device application.

9. The site diagram system from claim 1, wherein:
said site diagram system further comprises an assets list related each among a one or more placed icons;
said assets list tracks data and inventory levels related to said one or more placed icons; and
said assets list is provided for planning purposes.

10. The site diagram system from claim 1, wherein:
a one or more placed icons comprise an asset settings, an asset information, a work completed zone and an asset images;
said asset settings comprising attributes of said one or more placed icons;
said asset information comprising information about said one or more placed icons;
said work completed zone comprising a one or more tasks to be followed up on related to said one or more placed icons;
said asset images comprising a one or more images; and
said one or more images are related to said one or more placed icons and comprise a annotated image and a unannotated image.

11. The site diagram system from claim 1, wherein:
a one or more placed icons further comprise a security zones devices, a access control devices and a intrusion detection devices;
said security zones devices are overlaid on a survey map to define secure areas within a site location; and
said access control devices and said intrusion detection devices can be configured to protect said security zones devices and create alert signals for access events related to said security zones devices.

12. The site diagram system from claim 1, wherein:
a one or more placed icons can be grouped together in a one or more containers, wherein,
each of said one or more containers comprise a one or more zones related to
each of said one or more placed icons within said one or more containers.

13. The site diagram system from claim 1210, wherein:
a device application is configured to
create a new container when said user drags said new container onto a survey map,
combine a one or more of said one or more placed icons into said new container, and
configuring an asset settings for said new container.

14. The site diagram system from claim 1, wherein:
a one or more placed icons comprise a video surveillance devices, a access control devices, a intrusion detection devices, a information technology devices, and a security zones devices.

15. A site diagram system for use by a user for capturing a physical and/or logical layout of a one or more networked devices, to plan a one or more sites or to create a system diagram or a install checklist, wherein:
said site diagram system comprising a one or more computers;
said one or more computers comprising a processor and a memory;
said processor configured to run a device application;
said device application configured to create said system diagram;
said device application comprises a surveys list comprising a record of a one or more surveys comprising at least a first survey;
each among said one or more surveys comprising a data collected by said user concerning a site location;
said one or more surveys comprising a survey map and a one or more placed icons;
said survey map comprising a representation of said site location including floor plans and similar;
said one or more placed icons comprising representations of assets to be placed on said survey map;
said one or more placed icons each comprise an asset settings;
said device application comprises said survey map configured to receive a one or more among said one or more placed icons and to capture said asset settings related to said one or more placed icons;
said one or more placed icons can be grouped together in a one or more containers, wherein,
each of said one or more containers comprise a one or more zones related to
each of said one or more placed icons within said one or more containers; and
said device application is configured to
create a new container when said user drags said new container onto said survey map,
combine a one or more of said one or more placed icons into said new container, and
configuring said asset settings for said new container.

16. A site diagram system for use by a user for capturing a physical and/or logical layout of a one or more networked devices, to plan a one or more sites or to create a system diagram or a install checklist, wherein:
said site diagram system comprising a one or more computers;
said one or more computers comprising a processor and a memory;
said processor configured to run a device application;
said device application configured to create said system diagram;
said device application comprises a surveys list comprising a record of a one or more surveys comprising at least a first survey;
each among said one or more surveys comprising a data collected by said user concerning a site location;
said one or more surveys comprising a survey map and a one or more placed icons;
said survey map comprising a representation of said site location including floor plans and similar;
said one or more placed icons comprising representations of assets to be placed on said survey map;
said one or more placed icons each comprise an asset settings;
said device application comprises said survey map configured to receive a one or more among said one or more placed icons and to capture said asset settings related to said one or more placed icons;
said one or more placed icons comprise a camera icon;
said camera icon comprise a representation of a video surveillance devices; and
said device application is configured to capture a depth of field data for said camera icon by
receiving said camera icon in said survey map,
displaying a depth of field input markers on said camera icon,
receiving a depth input, an angle input, and a one or more width inputs with said depth of field input markers,
rendering a depth of field indication on said camera icon, and
recording said depth of field data for said camera icon.
